(19) United States
(12) Patent Application Publication
(10) Pub. No.: US 2026/0235733 A1
(43) Pub. Date: Aug. 13, 2026

(54) OBSERVATION APPARATUS AND OBSERVATION METHOD

(71) Applicants: STANLEY ELECTRIC CO., LTD., Tokyo (JP); NATIONAL UNIVERSITY CORPORATION CHIBA UNIVERSITY, Chiba-shi (JP)

(72) Inventors: Takumi IKEDA, Tokyo (JP); Yasuyuki KAWAKAMI, Tokyo (JP); Tatsuo SHIINA, Chiba-shi (JP)

(73) Assignees: STANLEY ELECTRIC CO., LTD., Tokyo (JP); NATIONAL UNIVERSITY CORPORATION CHIBA UNIVERSITY, Chiba-shi (JP)

(21) Appl. No.: 19/536,696

(22) Filed: Feb. 11, 2026

(30) Foreign Application Priority Data
Feb. 13, 2025 (JP) 2025-021607

(51) Int. Cl. G01S 7/481; G01S 7/497; G02B 27/01

(52) U.S. Cl. CPC G01S 7/4817; G01S 7/497; G02B 27/0172

(57) ABSTRACT

The observation apparatus includes a distance acquisition unit that acquires a distance to an observation target object, an optimum transmission optical axis angle acquisition unit that acquires an optimum transmission optical axis angle that is a transmission optical axis angle at which a coupling efficiency at the distance is maximized in a case where the coupling efficiency is an area of a superimposed region of a transmission light visual field and a reception light visual field/an area of the transmission light visual field and an angle between a transmission optical axis of the transmission light visual field and a reception optical axis of the reception light visual field is a transmission optical axis angle.

### INCORPORATION BY REFERENCE

This application is based upon and claims the benefit of priority from Japanese patent application No. 2025-021607, filed on Feb. 13, 2025, the disclosure of which is incorporated herein in its entirety by reference.

### BACKGROUND

The present disclosure relates to an observation apparatus and an observation method.

International Patent Publication No. WO 2003/073127 discloses an observation apparatus that performs LiDAR observation on the basis of observation light with respect to laser light emitted toward an observation target object.

On the other hand, the present inventors have studied an observation apparatus that performs LiDAR observation by using deep ultraviolet light. According to an observation apparatus that performs LiDAR observation by using deep ultraviolet light, it is possible to determine not only a distance to an observation target but also the property of the observation target. However, since information such as not only the presence or absence of a signal but also the intensity is required, the degree of accuracy with which the determination can be made depends on an S/N ratio in the detection target. Therefore, the present inventors have studied to increase a signal intensity from an observation target and improve an S/N ratio.

### SUMMARY

However, International Patent Publication No. WO 2003/073127 does not disclose that an S/N ratio is improved by increasing a signal intensity from an observation target in an observation apparatus that performs LiDAR observation by using deep ultraviolet light, and there is room for improvement in that respect.

The present disclosure has been made to solve such a problem, and an object of the present disclosure is to provide an observation apparatus and an observation method capable of improving an S/N ratio by increasing a signal intensity from an observation target in the observation apparatus that performs LiDAR observation by using deep ultraviolet light.

An observation apparatus according to the present disclosure includes a transmission unit, which has a transmission light visual field, configured to transmit, in the transmission light visual field, pulse light having a wavelength belonging to an ultraviolet region of a solar blind band, a reception unit, which has a reception light visual field, configured to receive reflected light within the reception light visual field among pieces of reflected light of the pulse light reflected by an observation target object, and a control analysis unit configured to receive a signal from the reception unit, in which the transmission unit includes a semiconductor light emitting element configured to emit the pulse light, and a transmission optical system configured to control the pulse light emitted by the semiconductor light emitting element such that the pulse light emitted by the semiconductor light emitting element is transmitted within the transmission light visual field, the reception unit includes a reception optical system configured to collect reflected light in the reception light visual field, and a light receiving element configured to receive the collected reflected light and output a signal corresponding to the received reflected light, the control analysis unit includes a distance acquisition unit configured to acquire a distance to the observation target object, an optimum transmission optical axis angle acquisition unit configured to acquire an optimum transmission optical axis angle that is a transmission optical axis angle at which a coupling efficiency at the distance is maximized in a case where a coupling efficiency is an area of a superimposed region of the transmission light visual field and the reception light visual field/an area of the transmission light visual field, and an angle between a transmission optical axis of the transmission light visual field and a reception optical axis of the reception light visual field is a transmission optical axis angle, and a transmission optical axis adjustment unit configured to adjust the transmission optical axis angle of the transmission unit to the optimum transmission optical axis angle, and the control analysis unit includes an observation data generation unit configured to adjust the transmission optical axis angle to the optimum transmission optical axis angle, and then generate LiDAR data that is observation data on the basis of the signal output from the light receiving element.

With such a configuration, the S/N ratio can be improved by increasing the signal intensity from the observation target in the observation apparatus that performs the LiDAR observation by using the deep ultraviolet light.

Another observation apparatus according to the present disclosure includes a transmission unit, which has a transmission light visual field, configured to transmit, in the transmission light visual field, pulse light having a wavelength belonging to an ultraviolet region of a solar blind band, a reception unit, which has a reception light visual field, configured to receive reflected light within the reception light visual field among pieces of reflected light of the pulse light reflected by an observation target object; and a control analysis unit configured to receive a signal from the reception unit, in which the transmission unit includes a semiconductor light emitting element configured to emit the pulse light, and a transmission optical system configured to control the pulse light emitted by the semiconductor light emitting element such that the pulse light emitted by the semiconductor light emitting element is transmitted within the transmission light visual field, the reception unit includes a reception optical system configured to collect reflected light in the reception light visual field, and a light receiving element configured to receive the collected reflected light and output a signal corresponding to the received reflected light, the control analysis unit includes a distance range acquisition unit configured to acquire a distance range of the observation target object, an optimum transmission optical axis angle acquisition unit configured to acquire an optimum transmission optical axis angle that is a transmission optical axis angle corresponding to a coupling efficiency related to the distance range in a case where a coupling efficiency is an area of a superimposed region of the transmission light visual field and the reception light visual field/an area of the transmission light visual field, and an angle between a transmission optical axis of the transmission light visual field and a reception optical axis of the reception light visual field is a transmission optical axis angle, and a transmission optical axis adjustment unit that adjusts the transmission optical axis angle of the transmission unit to the optimum transmission optical axis angle, and the control analysis unit adjusts the transmission optical axis angle to the optimum transmission optical axis angle, and then generates LiDAR data that is observation data on the basis of the signal output from the light receiving element.

With such a configuration, the S/N ratio can be improved by increasing the signal intensity from the observation target in the observation apparatus that performs the LiDAR observation by using the deep ultraviolet light.

The observation apparatus may further include a division unit configured to divide a distance range of the observation target object into intervals, in which the optimum transmission optical axis angle acquisition unit may acquire an optimum transmission optical axis angle that is a transmission optical axis angle at which the coupling efficiency is maximized for each of the intervals after division, the transmission optical axis adjustment unit may adjust the transmission optical axis angle to the optimum transmission optical axis angle for each of the intervals after the division, and the control analysis unit may adjust the transmission optical axis angle to the optimum transmission optical axis angle for each of the intervals after the division, and then generate LiDAR data that is observation data on the basis of the signal output from the light receiving element.

According to the present disclosure, it is possible to provide an observation apparatus and an observation method capable of improving an S/N ratio by increasing a signal intensity from an observation target in the observation apparatus that performs LiDAR observation by using deep ultraviolet light.

The above and other objects, features and advantages of the present disclosure will become more fully understood from the detailed description given hereinbelow and the accompanying drawings.

### BRIEF DESCRIPTION OF DRAWINGS

FIG. 1 is a schematic configuration diagram of an observation apparatus;

FIG. 2 is a longitudinal sectional view (schematic view) of the observation apparatus shown in FIG. 1;

FIG. 3 is a graph showing a change pattern of a visual field coupling ratio in a case where a transmission light viewing angle is 10 mrad and a reception light viewing angle is 3 mrad;

FIG. 4 is an enlarged view of a portion at a distance of 0 to 30 m in FIG. 3;

FIG. 5 is a graph showing a change pattern of a visual field coupling ratio in a case where a transmission light viewing angle is 10 mrad and a reception light viewing angle is 5 mrad;

FIG. 6 is an enlarged view of a portion at a distance of 0 to 30 m in FIG. 5;

FIG. 7 is a conceptual diagram of observation data (LiDAR data) generation processing;

FIG. 8 is a schematic configuration diagram of an observation apparatus;

FIG. 9 is a graph showing an emission spectrum of a deep ultraviolet LED;

FIG. 10 is a diagram showing a state in which light (pulse light) emitted from the deep ultraviolet LED (light emitting surface) is also transmitted in a direction inclined with respect to an optical axis of a transmission unit;

FIG. 11 shows an example of a drive circuit;

FIG. 12A shows an example of transmission characteristics of pulse light;

FIG. 12B shows an example of transmission characteristics of pulse light;

FIG. 13 is a graph showing a relationship between a supply voltage (V) and a frequency (MHz);

FIG. 14 is a schematic diagram of a reception unit 30 extracted from FIG. 8;

FIG. 15 is a schematic configuration diagram of an observation apparatus;

FIG. 16 is a cross-sectional view of a first reception mirror;

FIG. 17 is a cross-sectional view of a second reception mirror;

FIG. 18 shows a reflection spectrum of reflected light by each reception mirror;

FIG. 19 shows an example of an environment in which automatic deviation calibration and target object measurement are performed;

FIG. 20 shows an environment example in which target object measurement is performed;

FIG. 21 is a flowchart showing automatic deviation calibration processing for calculating apparatus deviations;

FIG. 22A shows an example of an acquired LiDAR signal;

FIG. 22B shows an example of a LiDAR signal after correction;

FIG. 23 is a flowchart showing target object measurement processing;

FIG. 24 shows examples of parameters used for automatic adjustment of a transmission optical axis angle;

FIG. 25 is a flowchart showing first automatic adjustment of a transmission optical axis angle;

FIG. 26A is a diagram showing initial measurement in the first automatic adjustment of a transmission optical axis angle;

FIG. 26B is a diagram for describing main measurement;

FIG. 27 is a flowchart showing second automatic adjustment of a transmission optical axis angle;

FIG. 28A is a view showing initial measurement in the second automatic adjustment of a transmission optical axis angle;

FIG. 28B is a diagram for describing main measurement;

FIG. 29 is a flowchart showing third automatic adjustment of a transmission optical axis angle;

FIG. 30A is a table showing a relationship between a transmission optical axis angle and a coupling efficiency;

FIG. 30B is a table showing a relationship between a transmission optical axis angle and a coupling efficiency;

FIG. 31 is a flowchart showing a modified example of the first automatic adjustment of a transmission optical axis angle (optical axis);

FIG. 32 shows an example of a distance-transmission optical axis angle table;

FIG. 33(a) is a longitudinal sectional view (schematic view) of an observation apparatus of a first embodiment;

FIG. 33(b) is a longitudinal sectional view (schematic view) of an observation apparatus of a second embodiment;

FIG. 34 is a longitudinal sectional view (schematic view) of an observation apparatus of a third embodiment;

FIG. 35 is a longitudinal sectional view (schematic view) of an observation apparatus according to a modified example;

FIG. 36 shows a disposition example of a semiconductor light emitting element (deep ultraviolet LED);

FIG. 37 is a schematic configuration diagram of an observation apparatus used in the first automatic adjustment of a transmission optical axis angle;

FIG. 38 is a schematic configuration diagram of an observation apparatus used in the second automatic adjustment of a transmission optical axis angle;

FIG. 39 is a schematic configuration diagram of an observation apparatus used in the third automatic adjustment of a transmission optical axis angle; and

FIG. 40 is a diagram showing a hardware configuration example of the observation apparatus according to the present disclosure.

### DESCRIPTION OF EMBODIMENTS

Hereinafter, an observation apparatus 10 according to an embodiment of the present disclosure will be described with reference to the accompanying drawings. In the drawings, corresponding components are denoted by the same reference numerals, and repeated descriptions are omitted.

### First Embodiment

### <Outline of Observation Apparatus 10>

First, an outline of the observation apparatus 10 according to the present embodiment will be described.

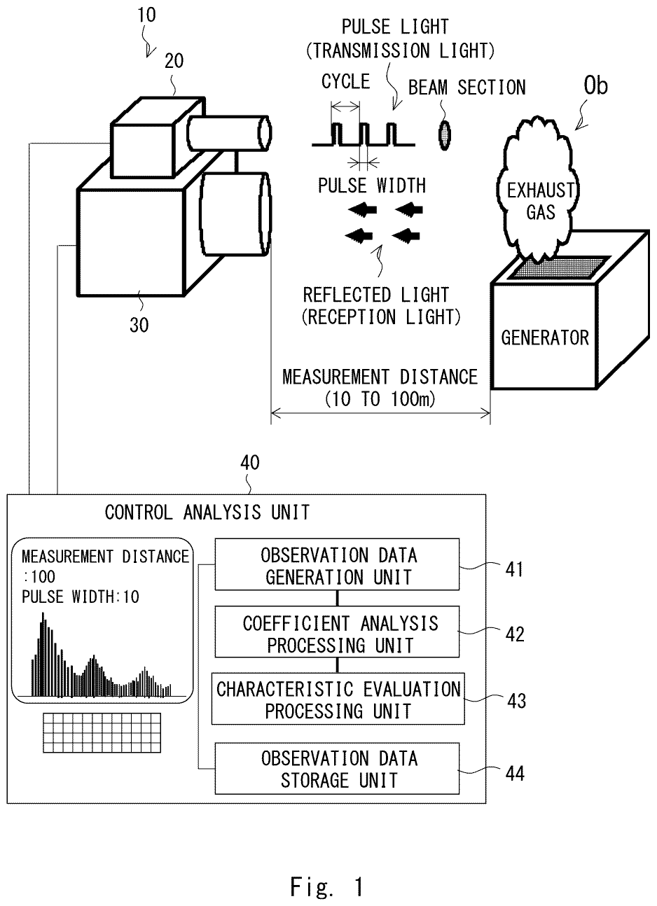

FIG. 1 is a schematic configuration diagram of the observation apparatus 10.

The observation apparatus 10 of the present embodiment is an apparatus (LiDAR apparatus) that remotely observes an observation target object Ob (for example, airborne particles such as aerosols and dust) existing at a short distance (for example, 10 to 150 m) in a non-contact manner.

As shown in FIG. 1, the observation apparatus 10 includes a transmission unit 20, a reception unit 30, and a control analysis unit 40.

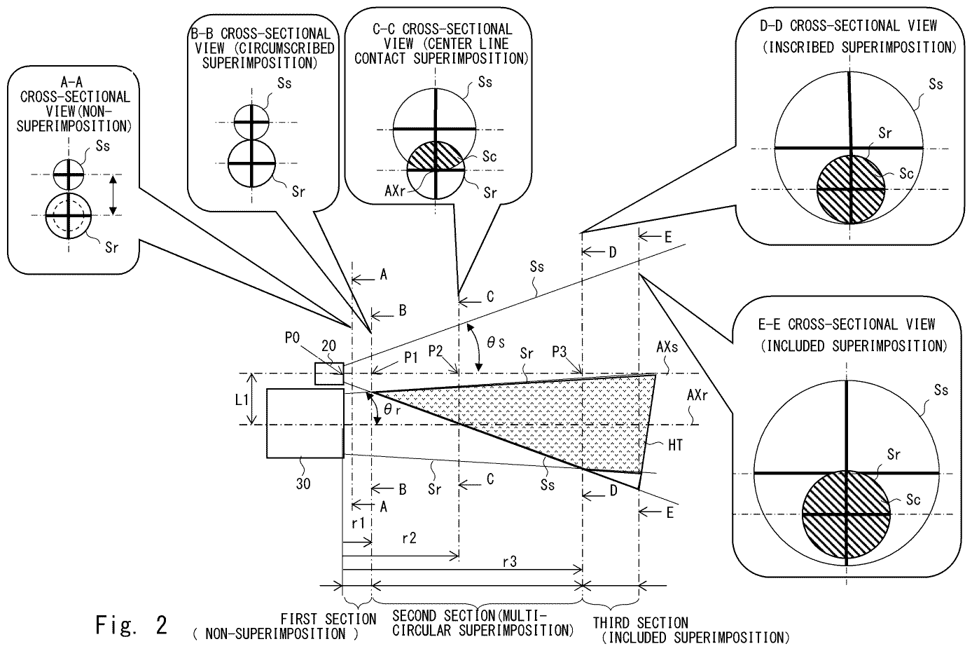

FIG. 2 is a longitudinal sectional view (schematic view) of the observation apparatus 10 shown in FIG. 1.

As shown in FIG. 2, the transmission unit 20 has a transmission light visual field Ss, and transmits pulse light (hereinafter, also referred to as transmission light) having a wavelength (for example, 265 nm) belonging to an ultraviolet region of the solar blind band within the transmission light visual field Ss. On the other hand, the reception unit 30 has a reception light visual field Sr, receives reflected light (reflected pulse light) reflected by the observation target object Ob and returning into the reception light visual field Sr among pieces of the transmission light (pulse light), and outputs a pulse electrical signal (electrical signal of a pulse wave) corresponding to the received reflected light. The pulse light may be spontaneous emission light (incoherence light).

An optical axis AXs of the transmission unit 20 and an optical axis AXr of the reception unit 30 are disposed in a state of being separated from each other and being parallel to each other. A distance L1 between the optical axis AXs of the transmission unit 20 and the optical axis AXr of the reception unit 30 is, for example, 85 mm.

The transmission light visual field Ss is a conical region centered on the optical axis AXs of the transmission unit 20 and having a diameter that increases as a distance from the transmission unit 20 increases along the optical axis AXs of the transmission unit 20. The minimum diameter (in FIG. 2, the diameter of the left end portion) of the transmission light visual field Ss is, for example, 60 mm. A transmission light viewing angle θs defining the transmission light visual field Ss is, for example, 10 mrad (0.57°).

On the other hand, the reception light visual field Sr is a conical region centered on the optical axis AXr of the reception unit 30 and having a diameter that increases as a distance from the reception unit 30 increases along the optical axis AXr of the reception unit 30. The minimum diameter (in FIG. 2, the diameter of the left end portion) of the reception light visual field Sr is, for example, 100 mm. A reception light viewing angle θr defining the reception light visual field Sr is, for example, 3 mrad (0.17°) or 5 mrad (0.29°).

As described above, the transmission light viewing angle θs is set to be larger than the reception light viewing angle θr.

Next, overlapping (superimposition) of the transmission light visual field Ss and the reception light visual field Sr will be described.

As described above, the optical axis AXs of the transmission unit 20 and the optical axis AXr of the reception unit 30 are disposed in a state of being separated from each other and parallel to each other, the transmission light visual field Ss and the reception light visual field Sr are each a conical region, and the transmission light viewing angle θs is set to be larger than the reception light viewing angle θr.

As a result, the transmission light visual field Ss and the reception light visual field Sr form a superimposed light visual field Sc by overlapping each other as shown in FIG. 2 (see a hatching region HT in FIG. 2 and the superimposed light visual field Sc in each cross-sectional view). Next, the superimposed light visual field Sc which is an overlap of the transmission light visual field Ss and the reception light visual field Sr will be specifically described.

The ratio of the superimposed light visual field Sc to the transmission light visual field Ss can be expressed by a visual field coupling ratio Crs. The visual field coupling ratio Crs is calculated by using the following Formula 1.

$$Visual field coupling ratio Crs = superimposed light visual field Sc / transmission light visual field Ss \qquad ( Formula 1 )$$

However, the superimposed light visual field Sc is an area of a region where the transmission light visual field Ss and the reception light visual field Sr overlap each other in each cross section (see each cross-sectional view in FIG. 2). The transmission light visual field Ss is an area of the transmission light visual field Ss in each cross section.

The large visual field coupling ratio Crs indicates that an amount of the reflected light (reflected pulse light) reflected by the observation target object Ob and returning to the reception light visual field Sr is large.

As shown in FIG. 2, the outer edge of the transmission light visual field Ss circumscribes the outer edge of the reception light visual field Sr at a first position P1 separated from a lens barrel distal end position P0 by a first distance r1 (see the cross-sectional view taken along line B-B in FIG. 2). In addition, the outer edge of the transmission light visual field Ss is in contact with the optical axis AXr of the reception unit 30 at a second position P2 separated from the lens barrel distal end position P0 by a second distance r2 (see the cross-sectional view taken along line C-C in FIG. 2). In addition, the outer edge of the reception light visual field Sr is inscribed in the outer edge of the transmission light visual field Ss at a third position P3 separated from the lens barrel distal end position P0 by a third distance r3 (see the cross-sectional view taken along line D-D in FIG. 2). Further, at each position beyond the third position P3, the outer edge of the reception light visual field Sr is included in the outer edge of the transmission light visual field Ss without being in contact with the outer edge of the transmission light visual field Ss (see the cross-sectional view taken along line E-E in FIG. 2).

Next, a change pattern of the visual field coupling ratio Crs will be described.

First, a change pattern of the visual field coupling ratio Crs in a case where the transmission light viewing angle θs is 10 mrad and the reception light viewing angle θr is 3 mrad will be described.

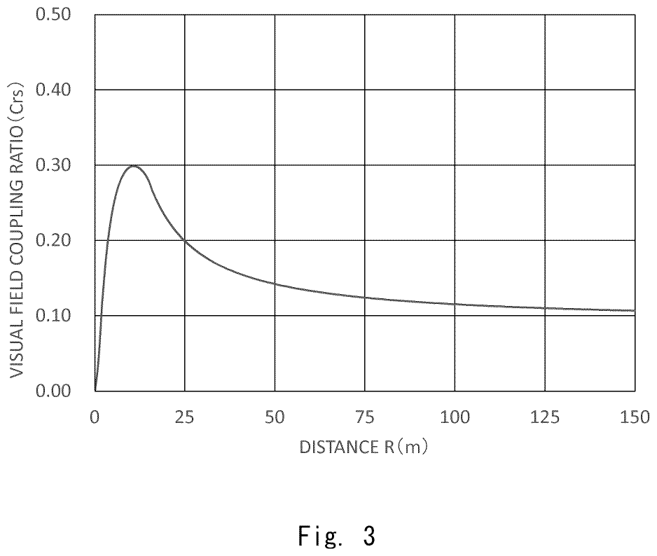

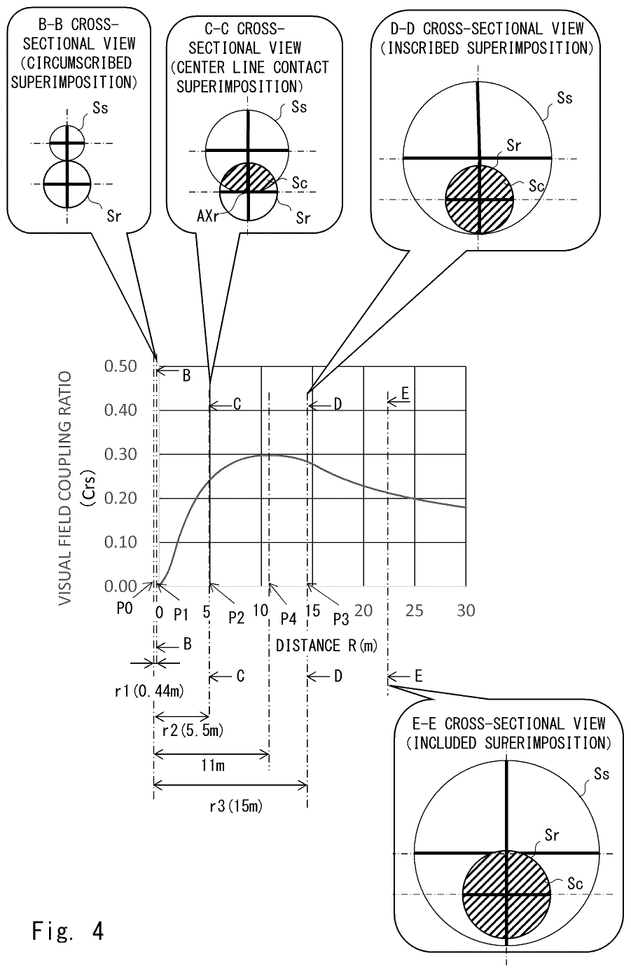

FIG. 3 is a graph showing a change pattern of the visual field coupling ratio Crs in a case where the transmission light viewing angle θs is 10 mrad and the reception light viewing angle θr is 3 mrad. FIG. 4 is an enlarged view of a portion at a distance of 0 to 30 m in FIG. 3.

As shown in FIG. 4, in a case where the transmission light viewing angle θs is 10 mrad and the reception light viewing angle θr is 3 mrad, the first position P1 is a position separated from the transmission unit 20 (lens barrel distal end position P0) by the first distance r1 (0.44 m) along the optical axis AXs of the transmission unit 20. The second position P2 is a position separated from the transmission unit 20 (lens barrel distal end position P0) by the second distance r2 (5.5 m) along the optical axis AXs of the transmission unit 20. The third position P3 is a position separated from the transmission unit 20 (lens barrel distal end position P0) by the third distance r3 (15 m) along the optical axis AXs of the transmission unit 20. In addition, the fourth position P4 is a position at which the visual field coupling ratio Crs is maximized and which is 11 m away from the transmission unit 20 (lens barrel distal end position P0) along the optical axis AXs of the transmission unit 20.

The distance region from the lens barrel distal end position P0 to the first position P1 is a region in which the outer circumference of the transmission light visual field Ss and the outer circumference of the reception light visual field Sr are separated from each other. Therefore, since the superimposed light visual field Sc is not formed, the visual field coupling ratio Crs is zero. Next, the distance region from the first position P1 to the second position P2 is a distance region from the point where the outer circumference of the transmission light visual field Ss is in contact with the outer circumference of the reception light visual field Sr to the optical axis AXr of the reception light visual field Sr. In this region, the visual field coupling ratio Crs increases steeply in accordance with the enlargement of the superimposed light visual field Sc. Next, the distance region from the second position P2 to the third position P3 is a region in which the outer circumference of the transmission light visual field Ss exceeds the optical axis AXr of the reception light visual field Sr and reaches the outer circumference on the far side of the reception light visual field Sr. In this region, since the transmission light visual field Ss also enlarges while the superimposed light visual field Sc enlarges, the visual field coupling ratio Crs gradually increases to reach a maximum value and then decreases. Finally, the distance region beyond the third position P3 is a distance region in which the transmission light visual field Ss includes the reception light visual field Sr. In this region, the superimposed light visual field Sc and the reception light visual field Sr are equal to each other, but since the enlargement ratio of the transmission light visual field Ss is large, the visual field coupling ratio Crs gradually decreases.

Next, a change pattern of the visual field coupling ratio Crs in a case where the transmission light viewing angle θs is 10 mrad and the reception light viewing angle θr is 5 mrad will be described.

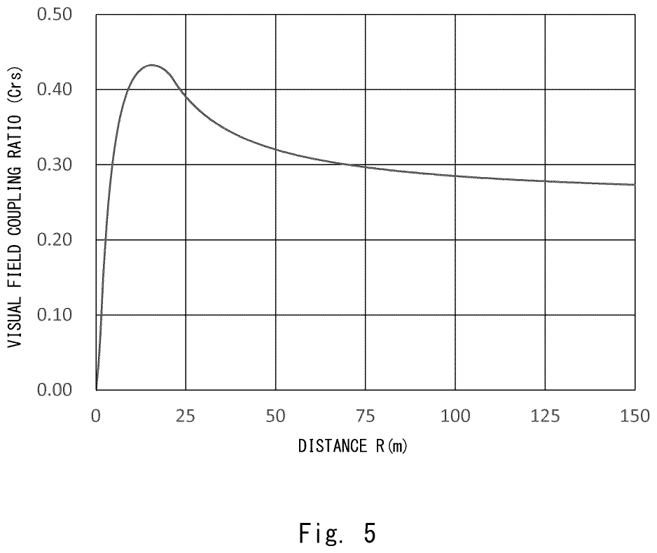

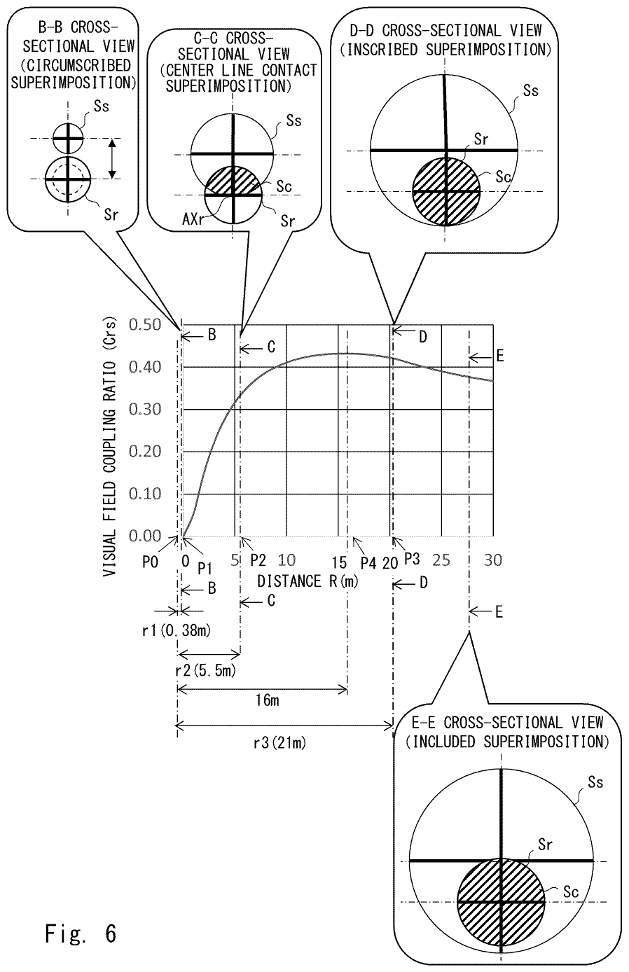

FIG. 5 is a graph showing a change pattern of the visual field coupling ratio Crs in a case where the transmission light viewing angle θs is 10 mrad and the reception light viewing angle θr is 5 mrad. FIG. 6 is an enlarged view of a portion at a distance of 0 to 30 m in FIG. 5.

As shown in FIG. 6, in a case where the transmission light viewing angle θs is 10 mrad and the reception light viewing angle θr is 5 mrad, the first position P1 is a position separated from the transmission unit 20 (lens barrel distal end position P0) by the first distance r1 (0.38 m) along the optical axis AXs of the transmission unit 20. The second position P2 is a position separated from the transmission unit 20 (lens barrel distal end position P0) by the second distance r2 (5.5 m) along the optical axis AXs of the transmission unit 20. The third position P3 is a position separated from the transmission unit 20 (lens barrel distal end position P0) by the third distance r3 (21 m) along the optical axis AXs of the transmission unit 20. In addition, the fourth position P4 is a position at which the visual field coupling ratio Crs is maximized and which is 16 m away from the transmission unit 20 (lens barrel distal end position P0) along the optical axis AXs of the transmission unit 20.

The change in the visual field coupling ratio Crs in each distance region from the lens barrel distal end position P0 to the first position P1, from the first position P1 to the second position P2, from the second position P2 to the third position P3, and beyond the third position P3 is similar to the case where the reception light viewing angle θr is 3 mrad. However, since the reception light viewing angle θr of the reception light visual field Sr is as large as 5 mrad, the visual field coupling ratio Crs at the same observation distance increases.

As described above, the observation can be performed from a distance beyond the first position P1 (circumscribed superimposition distance) where the superimposed light visual field Sc is formed. In addition, it is preferable that the observation is performed at a distance beyond the second position P2 at which the superimposed light visual field Sc is about half or more of the reception light visual field Sr (center line contact superimposition distance). Furthermore, in consideration of the missing portion of the superimposed light visual field Sc and the visual field coupling ratio Crs, the observation is preferably performed at a distance beyond the third position P3 at which the superimposed light visual field Sc coincides with the reception light visual field Sr (inscribed superimposition distance). Note that, since the transmission unit 20 and the reception unit 30 are separated in the observation apparatus 10, there is no influence due to light shielding by the transmission unit 20 in the distance region beyond the first position P1. In addition, the optical axis AXs of the transmission light visual field Ss and the optical axis AXr of the reception light visual field Sr are disposed to be separated from and parallel to each other in the observation apparatus 10, so that the superimposed light visual field Sc does not have a missing portion in the distance region beyond the third position P3.

Here, the distance r2 from the lens barrel distal end position P0 to the second position P2 depends only on the transmission light viewing angle θs regardless of the reception light viewing angle θr. In this case, the distance r1 from the lens barrel distal end position P0 to the first position P1 can be shortened by increasing the reception light viewing angle θr, and the distance r3 from the lens barrel distal end position P0 to the third position P3 can be shortened by decreasing the reception light viewing angle θr.

Hereinafter, the section between the lens barrel distal end position P0 and the first position P1 will be referred to as a first section. The section between the first position P1 and the second position P2 will be referred to as a second section. The section between the second position P2 and the third position P3 will be referred to as a third section. The geometric correction element affecting the reception light in the three sections is included in the geometric efficiency factor Y(R) of the LiDAR equation.

The LiDAR equation is generally expressed by the following equation.

$$[ Math . 1 ]$$

$$P ( R ) = {P}_{0} Y ( R ) C \frac{β ( R )}{{R}^{2}} exp [ - 2 {\int }_{0}^{R} α ( R ) dr ]$$

Here, R is a distance, P is a reception light intensity, Po is a transmission light output, Y is a geometric efficiency factor, C is a device constant, β is a backscattering coefficient, and a is a dissipation coefficient (absorption+diffusion). In addition, P(R), Y(R), β(R), and α(R) respectively represent an intensity, a factor, and coefficients at the distance R. In addition, r is an elapsed distance up to the distance R. Each coefficient depends on a substance (particles floating in the air) constituting the observation target object Ob. Furthermore, in the description of the three sections, it is assumed that the observation target object Ob is uniformly distributed in the entire space in the depth direction from the lens barrel distal end position P0 to the observation limit distance (a maximum observation distance that will be described later) and in the plane direction of the transmission light visual field Ss and the reception light visual field Sr. That is, the three sections are inner spaces of the observation target object Ob.

In the first section, the transmission light visual field Ss and the reception light visual field Sr do not overlap each other. Therefore, in the first section, there is almost no reflected light (reflected pulse light) reflected by the observation target object Ob and returning into the reception light visual field Sr. That is, the first section is an unobservable section.

In the second section, since the visual field coupling ratio Crs increases or decreases, the amount of the reflected light (reflected pulse light) reflected by the observation target object Ob and returning into the reception light visual field Sr also increases or decreases. Specifically, the change in the visual field coupling ratio Crs is caused by a correlation between an increase in the overlapping ratio of the transmission light visual field Ss to the reception light visual field Sr and a relative decrease in the superimposed light visual field Sc according to the enlargement ratios (viewing angles θs and θr) of the transmission light visual field Ss and the reception light visual field Sr. Therefore, the amount of the reflected light (reflected pulse light) in the second section increases as the distance R increases, reaches the maximum value, and then decreases. That is, the second section is an observation transition section.

In the third section, since the visual field coupling ratio Crs decreases according to the enlargement ratios (viewing angles θs and θr) of the transmission light visual field Ss and the reception light visual field Sr, the reflected light (reflected pulse light) reflected by the observation target object Ob and returning into the reception light visual field Sr also decreases. That is, the third section is an observation stable section.

Since the transmission light visual field Ss and the reception light visual field Sr overlap each other as described above, it is possible to receive reflected light (reflected pulse light) reflected by the observation target object Ob and returning into the reception light visual field Sr. That is, the reception light intensities P(R) in the second section and the third section in which the reflected light (reflected pulse light) is obtained are corrected by the geometric efficiency factor Y(R) in Formula 1 on the basis of the visual field coupling ratio Crs. Therefore, the short distance measurement can be performed without being affected by the change in the superimposed light visual field Sc. As a result, the observation target object Ob existing at a short distance (beyond the first position P1) can be observed. That is, observation data (LiDAR data) of the observation target object Ob existing at a short distance (beyond the first position P1) can be generated with high accuracy.

In particular, the transmission light viewing angle θs is set to be larger than the reception light viewing angle θr (see FIG. 2). As a result, the distance from the lens barrel distal end position P0 to the first position P1 (first section) can be shortened, and the distance from the second position P2 to the third position P3 (second section) can also be shortened. The section distance from the third position P3 and beyond (third section) to the maximum observation distance (a distance defined by the pulse light interval of the transmission light) can be lengthened. In addition, in the second section and third section in which observation can be performed, when the reception light viewing angle θr is large, the visual field coupling ratio Crs can be increased, so that the reception light intensity P(R) can be increased.

On the other hand, when the reception light viewing angle θr is small, the resolution of the optical axis orthogonal plane is improved, and when the reception light viewing angle θr is large, the resolution of the optical axis orthogonal plane deteriorates. In addition, when the reception light viewing angle θr is small, the third distance r3 (see FIG. 2) becomes short, and when the reception light viewing angle θr is large, the third distance r3 becomes long.

From the above description, in a case where a short distance is observed with high resolution, the reception light viewing angle θr is preferably small (for example, 3 mrad). On the other hand, in the case of observing the reception light intensity P(R) from a distant place, the reception light viewing angle θr is preferably larger (for example, 5 mrad).

In addition, in a case where the observation target object Ob is a non-light shielding body such as aerosol, dust, fog, rainfall, or snowfall in the form of a screen (in a state of being thin in the distance direction), another observation target object in front of or behind the observation target object Ob can also be observed in the second section and the third section.

Since the reception light visual field Sr is included in the transmission light visual field Ss beyond the third position P3 (third section), a plurality of observation target objects Ob partially present in the reception light visual field Sr can be observed (measured). In a case where the transmission light is a linear beam (for example, laser light), LiDAR data of the observation target object Ob other than the observation target object Ob at the position where the transmission light is transmitted cannot be obtained.

Next, observation data (LiDAR data) generation processing will be described.

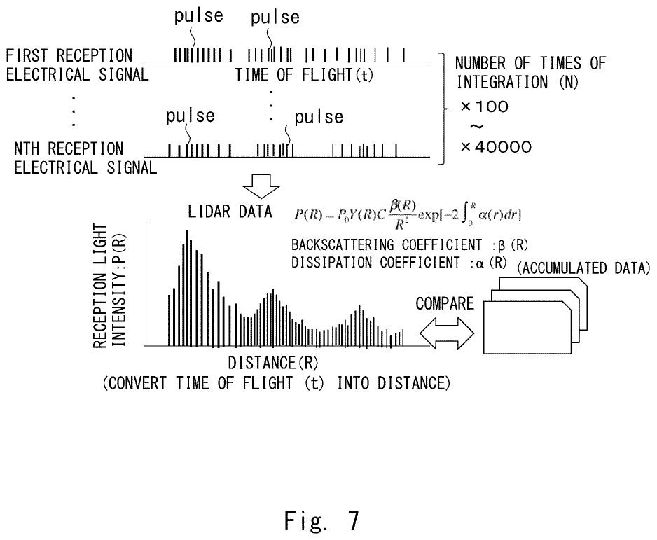

FIG. 7 is a conceptual diagram of observation data (LiDAR data) generation processing.

The observation data (LiDAR data) generation processing is executed by the control analysis unit 40. The control analysis unit 40 may be a dedicated device in which a device that will be described later for generating and processing observation data for the observation apparatus 10 is housed in a casing, or may be a composite device including another observation device such as an observation camera.

As shown in FIG. 1, the control analysis unit 40 includes an observation data generation unit 41, a coefficient analysis processing unit 42, a characteristic evaluation processing unit 43, and an observation data storage unit 44.

The observation data generation unit 41 divides a pulse electrical signal output by the reception unit 30 in response to the reflected light (reflected light (reflected pulse light; specifically, photons) that is reflected by the observation target object Ob and returns to the reception light visual field Sr) for each reception cycle by using a photon counting circuit (a circuit that performs photon counting), and integrates the electrical signals N times to generate observation data (LiDAR data). In FIG. 7, the lowermost graph is an example of observation data (LiDAR data). The generated observation data (LiDAR data) is stored (accumulated) in the observation data storage unit 44.

In FIG. 7, the first reception electrical signal to the Nth reception electrical signal represent pulse electrical signals divided for each reception cycle. In FIG. 7, each pulse pulse described in the graph on the right side of the first reception electrical signal represents a pulse electrical signal output according to reflected light (reflected light (reflected pulse light; and specifically photons) reflected by the observation target object Ob and returning into the reception light visual field Sr) received by the reception unit 30 during the reception cycle in a case where the first pulse light (transmission light) is transmitted. The same applies to each pulse pulse described in the graph on the right side of the Nth reception electrical signal.

The time of flight (t) of the first reception electrical signal represents the time of flight (round-trip time of flight) of the photons corresponding to each pulse pulse to and from the observation target object Ob. In the graph of the Nth reception electrical signal, the time of flight (t) is omitted.

Note that the present disclosure is not limited to the photon counting circuit, and any circuit may be used as long as the circuit executes photon counting. For example, a digital oscilloscope and a PC (an information processing apparatus such as a personal computer) may be used in combination.

The coefficient analysis processing unit 42 executes processing of calculating a spatial distribution (distance direction) of the observation target object Ob from an increase/decrease change in observation data (LiDAR data), evaluating the observation data (LiDAR data) with a LiDAR equation, and calculating the dissipation coefficient α and the backscattering coefficient β specific to the observation target object Ob.

For example, when the observation target object Ob is uniform atmosphere in the space from the lens barrel distal end position P0 to the maximum observation distance (Rmax), the reception light intensity P(R) indicates a change that increases according to the distance (R) and the geometric efficiency factor Y(R) and attenuates after reaching the maximum value. In addition, when the observation target object Ob is spatially uniform, the dissipation coefficient α(R) and the backscattering coefficient β(R) may be α and β because there is no change due to the distance. Therefore, since the LiDAR equation is Ln((P(R)R²)/Y(R))=−2αR+ln(P₀Cβ), the dissipation coefficient α can be obtained from the slope term −2αR, and the backscattering coefficient β can be obtained from the intercept term ln(P₀Cβ).

The characteristic evaluation processing unit 43 executes, for example, atmospheric evaluation at a fixed point and evaluation of smoke, dust, and the like.

For example, the atmospheric evaluation at a fixed point can be performed by periodically observing the atmosphere every year and evaluating the atmosphere by using backscattering coefficient β and dissipation coefficient α of fine particles such as aerosols contained in the observed atmosphere. In addition, the transition of the atmospheric state can be evaluated through comparison with observation values of the reference year. In this case, comparison with the disclosed standard atmosphere may be performed to estimate, for example, the type of fine particles floating in the space (see ex. Laser Radar Society of Japan, 4 (2020), Kuze, Measurement of Light Scattering of Aerosols and Atmospheric Molecules). The evaluation of fog, rain, and snow may also be performed in the same manner as the atmospheric evaluation at a fixed point.

Evaluation of smoke and dust, for example, evaluation of cleanliness of device exhaust, exhaust smoke from a chimney, on-road dust, and the like may be performed by comparing characteristics of the atmosphere other than the exhaust portion with characteristics of the atmosphere of the exhaust portion.

The observation data storage unit 44 is a nonvolatile storage unit such as a hard disk device or an SSD that stores the observation data (LiDAR data) generated by the observation data generation unit 41.

Since the control analysis unit 40 (observation data generation unit 41) has a function (known direct time of flight (dToF) method, photon counting, and the like) of measuring (calculating) the time of flight of the reflected light (photons) received by the reception unit 30 to the observation target object Ob, it is possible to measure (calculate) the time of flight (round-trip time of flight) of the photons corresponding to each pulse pulse to the observation target object Ob.

The observation data (LiDAR data) is generated by integrating (N-time integration) the first reception electrical signal to the Nth reception electrical signal. In the graph shown in the lowermost part of FIG. 7, the vertical axis represents a reception light intensity and corresponds to the number of photons. The horizontal axis represents a distance. This distance is obtained by converting the time of flight (t) into a distance.

Next, improvement in short distance observability, downsizing, and observation convenience by the observation apparatus 10 will be described. The short distance described herein is a distance of about several meters to several hundred meters.

### (Short Distance Observability)

The observation apparatus 10 can increase a transmission frequency of the transmission light (pulse light) transmitted from the transmission unit 20 from 1 megahertz (MHz) to about 10 MHz. For example, in a case where the observation target object Ob locally exists within a distance of about 50 m to 100 m, the maximum observation distance (Rmax) can be set to 150 m. The maximum observation distance is a distance defined by a transmission cycle of transmission light (pulse light). For example, in a case where the transmission cycle of the transmission light (pulse light) is 1 microsecond (μsec), the flight distance of the transmission light is 300 m. That is, the maximum observation distance (Rmax) is 150 m which is a distance at which the previously transmitted transmission light does not interfere with the next transmission light. The transmission frequency in this case is 1 MHz. Similarly, when the maximum observation distance (Rmax) is 15 m, the transmission cycle of the transmission light (pulse light) is 0.1 μsec and the transmission frequency is 10 MHz.

The LiDAR data is generated by integrating each pulse pulse of one unit cycle incident on the reception unit 30 a plurality of times. Therefore, the LiDAR data can be generated in a short time by increasing the transmission frequency of the transmission light (pulse light). In particular, since the apparent moving speed (moving angle per unit time) of the observation target object Ob at a short distance is large, short-time observation is important to improve a spatial resolution. For example, when the distance to the observation target object Ob is 100 m and the number of times of integration of the LiDAR data is 1000, if the transmission frequency is 1 MHz (transmission cycle 1 μsec), one observation time is 1 millisecond (msec). In this case, if the observation target object Ob moves at a wind speed of 3 m/s (a wind speed of about the breeze), the observation target object Ob moves by 3 mm between the start and the end of the observation. That is, the moving angle is 0.0017°. Therefore, the reception light viewing angle ratio (moving angle/reception light viewing angle θr) is 0.01 (1%) when the reception light viewing angle θr is 3 mrad (0.17°), and is 0.006 (0.6%) when the reception light viewing angle θr is 5 mrad (0.29°). When the distance to the observation target object Ob is 50 m, the moving angle is 0.0034°. Therefore, the reception light viewing angle ratio is 0.02 (2%) when the reception light viewing angle θr is 3 mrad, and is 0.012 (1.2%) when the reception light viewing angle θr is 5 mrad. As described above, by increasing the transmission frequency, even in a case where the observation target object Ob at a short distance is moving, it is possible to observe the observation target object Ob with high accuracy.

In addition, the observation apparatus 10 reduces the pulse width of the transmission light (pulse light) transmitted from the transmission unit 20 to about 1 nanosec (nsec). For example, the distance resolution is 1.5 m when the pulse width is 10 nsec, and the distance resolution is 0.15 m when the pulse width is 1 nsec. As described above, by narrowing the transmission light, the observation target object Ob can be observed with high accuracy in the short distance measurement.

The observation apparatus 10 sets the wavelength of the transmission light (pulse light) transmitted from the transmission unit 20 to a solar blind wavelength in a deep ultraviolet light band without atmospheric absorption (absorption by oxygen and nitrogen). Here, the solar blind wavelength in the deep ultraviolet light band is a deep ultraviolet wavelength band that significantly attenuates before reaching the ground surface among pieces of sunlight reaching the earth. Specifically, the solar blind wavelength is a wavelength on the longer wavelength side than the wavelength near the long-wavelength absorption edge of the absorption wavelengths of oxygen and nitrogen and on the shorter wavelength side than the long-wavelength absorption edge of the absorption wavelength of the ozone layer. Specifically, the solar blind wavelength is 230 nanometers (nm) or more and 300 nm or less. The solar blind wavelength is preferably 250 nm to 280 nm. With such a wavelength band, it is possible to perform observation with a low-output light source because there is no influence of external light and no influence of absorption of the atmosphere.

In addition, by setting the wavelength of the transmission light (pulse light) to the solar blind wavelength in the deep ultraviolet light band without atmospheric absorption, the backscattering coefficient β and the dissipation coefficient α of the fine particles contained in the observation target object Ob become larger than those of near-ultraviolet to infrared light. As a result, even when the thickness of the observation target object Ob in the distance direction is small, or even when the concentration of contained particles is low, observation can be performed. Specifically, the dissipation coefficient α increases in inverse proportion to the 1.25 power of the wavelength, and becomes about five times by shortening the wavelength from 900 nm to 265 nm. Since the backscattering coefficient β is approximately proportional to the dissipation coefficient α, the backscattering coefficient β similarly increases by about a factor of five. That is, it is possible to perform highly sensitive observation even at a short distance (a short passing distance of the observation target object Ob). In addition, the features of the observation target object Ob (for example, aerosol, smoke, dust, fog, rain, or snow) can be easily identified.

### (Downsizing)

The observation apparatus 10 uses a deep ultraviolet light emission diode (LED) which is a semiconductor light emitting element that emits deep ultraviolet light (for example, the wavelength thereof is 265 nm). The deep ultraviolet LED has a size of about 1 mm². In addition, the deep ultraviolet LED can also downsize a light transmission circuit that emits light having a high frequency and a narrow pulse width. In addition, a small lens having a small aperture (aperture φ of about 60 mm) can configure a collimated transmission system having a high light flux utilization ratio. Therefore, the transmission unit 20 can be downsized.

The observation apparatus 10 uses a photomultiplier tube (PMT) for ultraviolet rays corresponding to photon counting as a light receiving element. Therefore, the PMT is small. In addition, since the transmission light of the transmission unit 20 has a solar blind wavelength in a deep ultraviolet light band without atmospheric absorption, the main concentrator of the reception unit 30 can be a small lens or a reflecting mirror (aperture φ of about 100 mm). Therefore, the reception unit 30 can be downsized.

### (Observation Convenience)

The observation apparatus 10 enables observation to be performed regardless of day or night by using a semiconductor light emitting element (for example, an LED having a wavelength of 265 nm) that emits ultraviolet band light in a solar blind band without atmospheric absorption as a light source of the transmission unit 20. For example, it is possible to perform observation under fine weather in the daytime and observation under illumination such as a fluorescent lamp or a halogen lamp at night. As a result, it is possible to perform observation at regular intervals over day and night. In addition, since illumination can be projected to the observation target object Ob even at night, aiming at the observation target object Ob becomes easy.

### <First Configuration Example of Observation Apparatus 10>

Next, a specific first configuration example of the observation apparatus 10 will be described. Hereinafter, the observation apparatus 10 of the first configuration example will be referred to as an observation apparatus 10A.

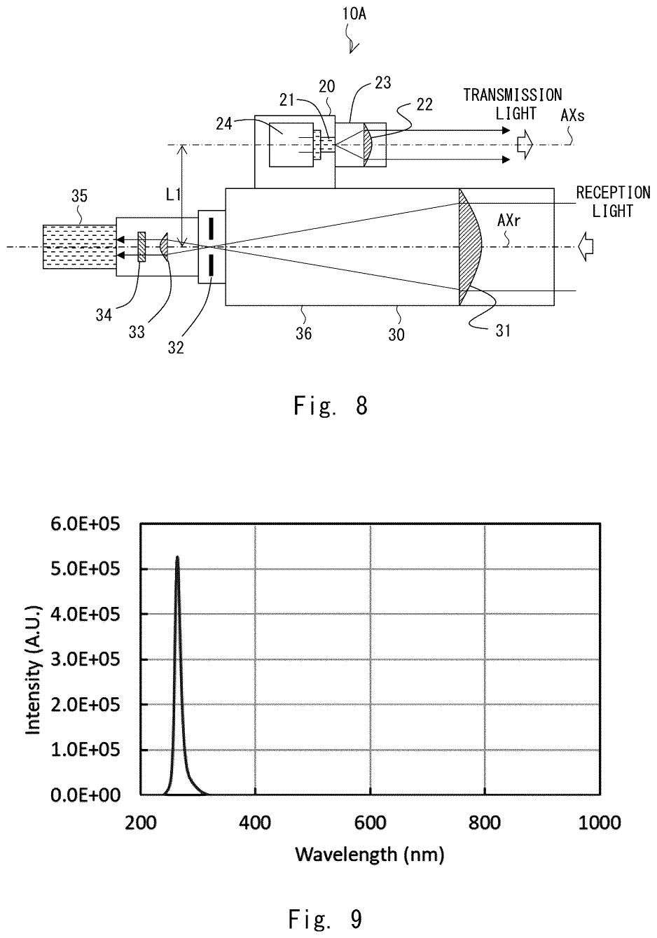

FIG. 8 is a schematic configuration diagram of the observation apparatus 10A.

The observation apparatus 10A is an observation apparatus (LiDAR apparatus) including a transmission unit 20 and a reception unit 30 of a refractive optical system.

As shown in FIG. 8, the observation apparatus 10A includes a transmission unit 20, a reception unit 30, and a control analysis unit 40 (not shown in FIG. 8). The optical axis AXs of the transmission unit 20 and the optical axis AXr of the reception unit 30 are disposed to be separated from and parallel to each other.

### <Transmission Unit 20>

The transmission unit 20 includes a semiconductor light emitting element 21 and a transmission lens 22 (an example of a transmission optical system of the present disclosure). In FIG. 8, the reference numeral 23 denotes a transmission lens barrel, and the reference numeral 24 denotes a drive circuit of the semiconductor light emitting element 21.

The semiconductor light emitting element 21 is a semiconductor light emitting element which has an excellent response speed (for example, high frequency and short pulse light can be emitted) and emits light (pulse light) having a wavelength belonging to the ultraviolet region of the solar blind band, and is, for example, a deep ultraviolet LED. Hereinafter, the semiconductor light emitting element 21 will also be referred to as a deep ultraviolet LED 21.

Hereinafter, an example in which a deep ultraviolet LED having a Lambertian light distribution (distribution) having a peak wavelength (center wavelength) of 265 nm and a half value angle of about 120° is used as the semiconductor light emitting element 21 will be described. Hereinafter, the semiconductor light emitting element 21 will also be referred to as a deep ultraviolet LED 21.

Specifications of the deep ultraviolet LED 21 are as described in the following table.

TABLE 1

| | |
|---|---|
| Spectrum (see FIG. 9) | λp = 265 nm (full width at |
| | half maximum = 12 nm) |
| Directional characteristic | Lambertian (half value angle 120°) |
| Light output | Continuous power 50 mW@3 W |
| | 1 mW to 500 mW at pulse output |
| Responsiveness | 1 ns |

The spectrum of the employed deep ultraviolet LED without atmospheric absorption is a peak wavelength (λp) of 265 nm and a full width at half maximum (fWHM) of 12 nm. The directional characteristic is Lambertian with a half-value angle of 120°. The light output is 50 mW at 3 W input power under continuous power (cw) conditions and 1 mW to 500 mW at pulse output. The responsiveness is 1 ns or more.

The deep ultraviolet LED 21 used for the transmission unit 20 of the observation apparatus 10A is sealed in a CAN package. The CAN package is mounted on a heat sink included in the drive circuit 24. A portion other than the light emission port of the CAN package is covered with a partition plate made of a material that absorbs stray light emitted from the deep ultraviolet LED. In addition to the CAN package, the deep ultraviolet LED may be mounted on a ceramic substrate such as aluminum oxide, silicon nitride, or aluminum nitride that has high thermal conductivity (for example, 30 to 200 W/m·K) and absorbs stray light. Further, the deep ultraviolet LED may be mounted on a ceramic inlay type glass epoxy substrate in which a ceramic is fitted in a portion where the deep ultraviolet LED is mounted. It is preferable to provide a heat sink on the back surface side (the surface opposite to the surface on which the deep ultraviolet LED is mounted) of the ceramic substrate or the ceramic inlay type glass epoxy substrate.

The deep ultraviolet LED 21 has a light emitting surface of 1.04 mm square. The light (pulse light) emitted from the deep ultraviolet LED is incoherent light or incoherence light (which is divergent light having a random phase and a wide full width at half maximum). The light (pulse light) emitted from the deep ultraviolet LED 21 is isotropic light (light having no polarization).

The transmission lens 22 is, for example, a condensing lens that is rotationally symmetric with respect to the optical axis AXs of the transmission unit 20. The transmission lens 22 is made of quartz glass that transmits the light emitted from the deep ultraviolet LED 21. The transmission lens 22 may be made of borosilicate glass, silicate glass, amorphous fluororesin, or the like that transmits deep ultraviolet light.

Specifications of the transmission lens 22 are as described in the following table.

TABLE 2

| Lens diameter φs | 60 mm |
|---|---|
| Transmission light viewing angle θs | 0.573° (10 mrad) |
| Focal length f | 52 mm |
| Uptake angle θi | 30° |

When an uptake angle θi (see FIG. 10) of the transmission lens 22 is 30° and the diameter φs (see FIG. 10) of the transmission lens 22 is 60 mm, the focal length f (see FIG. 10) is 52 mm. This can be calculated from the equation tan (θi)=(φs/2)/f. On the other hand, when the size Es of the deep ultraviolet LED 21 (light emitting surface) is 1.04 mm square, the transmission light viewing angle θs is about 10 mrad. This can be calculated from the equation of tan θs=(Es/2)/f.

The optical axis of the transmission lens 22 and the optical axis of the deep ultraviolet LED 21 (light emitting surface) coincide (substantially coincide) with the optical axis AXs of the transmission unit 20. The optical axis of the deep ultraviolet LED 21 (light emitting surface) passes through the center of the light emitting surface and extends in a direction perpendicular to the light emitting surface.

The focal point of the transmission lens 22 is disposed near the center of the deep ultraviolet LED 21 (light emitting surface). Therefore, light (pulse light) emitted from the deep ultraviolet LED 21 is collimated by the transmission lens 22. As a result, transmission light suitable for observation at a short distance (for example, 15 m to 150 m) can be obtained.

The beam diameter (aperture) of the transmission light is sufficiently larger than the observation target object Ob in order to stably observe (measure) the observation target object Ob (for example, particulates (aerosols) in the atmosphere). For example, the beam diameter (aperture) of the transmission light is 60 mm in diameter.

As described above, by using the condensing lens (collimating lens) as the transmission lens 22, the light (pulse light) emitted from the deep ultraviolet LED 21 can be formed into collimated light having a diameter equal to the lens diameter (60 mm) of the transmission lens 22.

On the other hand, the deep ultraviolet LED 21 (light emitting surface) is not a point light source but has a constant size. Therefore, the light (pulse light) emitted from the deep ultraviolet LED 21 (light emitting surface) is also transmitted in a direction inclined with respect to the optical axis AXs of the transmission unit 20.

FIG. 10 is a diagram showing a state in which pieces of light PL1 and PL2 (pulse light) emitted from the deep ultraviolet LED 21 (light emitting surface) are also transmitted in a direction inclined with respect to the optical axis AXs of the transmission unit 20.

As shown in FIG. 10, the light PL1 emitted from a center Pa of the deep ultraviolet LED 21 (light emitting surface) is refracted (collimated) by the transmission lens 22 and transmitted in the direction of the optical axis AXs of the transmission unit 20. On the other hand, the light PL2 emitted from a position Pb shifted downward with respect to the center of the deep ultraviolet LED 21 (light emitting surface) is refracted by the transmission lens 22 and transmitted in a direction inclined upward by a predetermined angle with respect to the optical axis AXs of the transmission unit 20. Similarly, although not shown, light emitted from a position shifted upward with respect to the center of the deep ultraviolet LED 21 (light emitting surface) is refracted by the transmission lens 22 and transmitted in a direction inclined downward by a predetermined angle with respect to the optical axis AXs of the transmission unit 20. The same applies to light emitted from other positions of the deep ultraviolet LED 21 (light emitting surface).

As a result, the transmission light visual field Ss becomes a conical region of which the diameter increases as a distance from the transmission unit 20 (lens barrel distal end position P0) increases along the optical axis AXs of the transmission unit 20 with the optical axis AXs of the transmission unit 20 as the center (see FIG. 2).

The transmission light visual field Ss (transmission light viewing angle θs) can be adjusted by changing the focal length f. For example, in a case where the uptake angle θi is constant, the transmission light viewing angle θs can be made wider than that before the focal length f is shortened by shortening the focal length f. In this case, the lens diameter φs of the transmission lens 22 decreases. Conversely, the transmission light viewing angle θs can be made narrower than that before the focal length f is increased by increasing the focal length f. In this case, the lens diameter φs of the transmission lens 22 increases. Thus, the transmission light viewing angle θs can be easily adjusted by using the deep ultraviolet LED 21 having the Lambertian directional characteristic and the transmission lens 22. That is, the transmission light visual field Ss can be easily made larger than the reception light visual field Sr.

The transmission lens barrel 23 is made of aluminum (Al), and the inner cylinder surface is subjected to antireflection treatment of a black alumite film that prevents (absorbs) reflection of emitted light (stray light) of the deep ultraviolet LED 21. The transmission lens barrel 23 may be made of a corrosion-resistant metal material such as stainless steel or invar, a resin material such as polycarbonate, acrylic, polypropylene, polyethylene, or epoxy, or a low thermal expansion ceramic material such as alumina or silica. The antireflection treatment may be matte black chromium plating, nickel plating treatment, or the like. In addition, ceramic coating treatment of black alumina or carbon may be used. By performing the antireflection treatment on the inner cylindrical surface of the transmission lens barrel 23 as described above, it is possible to prevent excess light (stray light) other than light directly entering the transmission lens 22 from the deep ultraviolet LED 21 from being reflected by the inner cylindrical surface and emitted from the transmission lens 22. That is, the transmission light can be transmitted at the predetermined transmission light viewing angle θs (transmission light visual field Ss), and the occurrence of the distance error of the LiDAR data can be prevented in the observation of the dToF method. That is, the reception light intensity P(R) can be observed with high accuracy.

The transmission lens barrel 23 may include a hood on the front side of the transmission lens 22. The inner cylindrical surface of the hood is also subjected to the same antireflection treatment as described above.

### <Drive Circuit 24>

Next, the drive circuit 24 will be described.

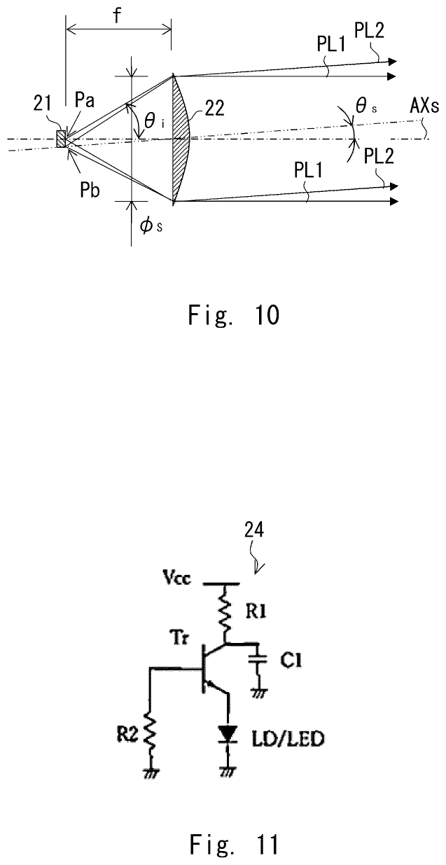

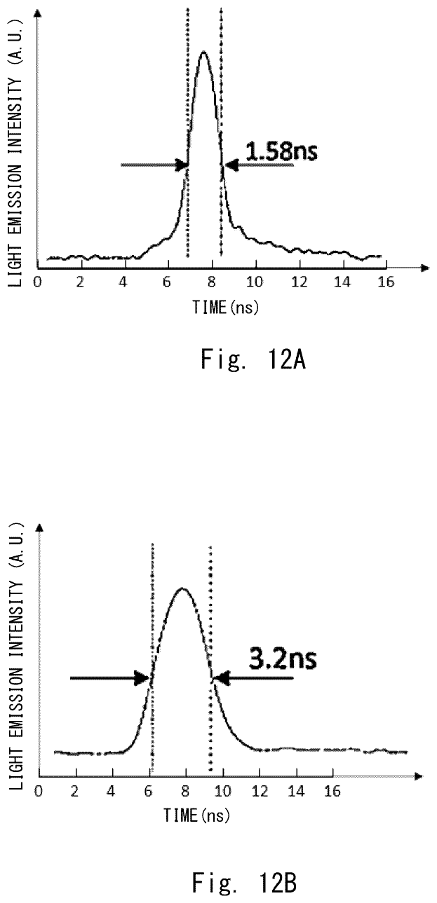

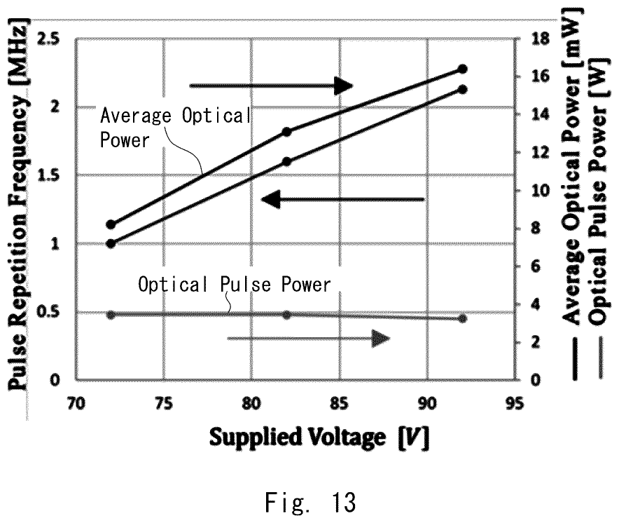

FIG. 11 shows an example of the drive circuit 24, and FIGS. 12A and 12B show examples of transmission characteristics of pulse light. FIG. 13 is a graph showing a relationship between a supply voltage (V) and a frequency (MHz). The drive circuit 24 shown in FIG. 11 is a drive circuit using avalanche breakdown of a transistor. In FIGS. 12A and 12B, the horizontal axis represents time (ns), and the vertical axis represents a relative value of emission intensity (A. U).

The drive circuit 24 is a drive circuit for realizing pulse light having a frequency of 1 MHz to 10 MHz and a pulse width of 1 ns to 10 ns as transmission light. The control analysis unit 40 controls the deep ultraviolet LED 21 via the drive circuit 24 to emit transmission light (pulse light) having a frequency of 1 MHz and a pulse width of 9.6 ns.

The pulse width of the transmission light is adjusted by selecting the capacitance of the capacitor C1 of the drive circuit 24. For example, by setting the capacitance of the capacitor C1 to a small capacitance or a large capacitance, the emission pulse width (full width at half maximum) can be adjusted to 1.58 ns (see FIG. 12A) or 3.2 ns (see FIG. 12B).

The frequency (emission light cycle) of the transmission light can be adjusted (controlled) by fixing a value of a resistor R1 of the drive circuit and selecting an applied voltage between Vcc and the ground voltage. For example, as shown in FIG. 13, by setting the applied voltage to 72 V to 92 V, the slow recharge time can be adjusted, and the emission light cycle can be controlled to 1 MHz to 2.1 MHz. The light intensity of the pulse light in this case can be substantially constant because the avalanche breakdown voltage of the transistor is constant. As another method, the frequency of the transmission light can be selected by setting the voltage between Vcc and the ground voltage constant and selecting a value of the resistor R1.

A distance resolution (spatial resolution) is determined by a pulse width of transmission light (pulse light). For example, when the pulse width is 1 ns, the distance resolution (spatial resolution) is 0.15 m (light speed c (m/s)·pulse width τ(s)/2). As a result, a detailed distribution of the observation target object Ob (for example, particles in space) can be observed. When the pulse width is 10 ns, the distance resolution (spatial resolution) is 1.5 m. As a result, the distribution of the observation target object Ob (for example, coarse particles in space) can be observed.

The observation distance (measurement distance) is determined by the frequency of the transmission light (pulse light). For example, in a case of a frequency of 1 MHz (cycle of 1 μs=1/1,000,000 (/s)), the observation maximum distance is 150 m (light speed c (m/s)·cycle f(s)/2). In addition, in the case of a frequency of 10 MHz, the observation maximum distance is 15 m. That is, the observation distance (measurement distance) can be set within a range in which the return light (reception light) of the previous transmission light does not overlap the emission time of the next transmission light.

Thus, the pulse width and the frequency of the transmission light can be easily adjusted by selecting a capacitor C1 and the resistor R1 of the drive circuit 24 and selecting the voltage between Vcc and the ground voltage. Specifically, by preparing and selecting capacitors C1a, C1b, C1c, . . . having different capacitances as the capacitors C1 and resistors R1a, R1b, R1c, . . . having different resistance values as the resistors R1, the pulse width or the frequency of the transmission light can be adjusted in a wide range.

### <Reception Unit 30>

As shown in FIGS. 8 and 14, the reception unit 30 includes a first reception lens 31 (an example of a reception optical system of the present disclosure), a field stop 32, a second reception lens 33, a reception filter 34, and a light receiving element 35. In FIG. 8, the reference numeral 36 denotes a reception lens barrel. FIG. 14 is a schematic diagram of the reception unit 30 extracted from FIG. 8.

The first reception lens 31 is, for example, a condensing lens that is rotationally symmetric with respect to the optical axis AXr of the reception unit 30. Similarly to the transmission lens 22, the first reception lens 31 (and the second reception lens 33) is (are) made of quartz glass. The first reception lens 31 collects reflected light PL3 and PL4 (reflected pulse light) reflected by the observation target object Ob and returning into the reception light visual field Sr among pieces of the transmission light (pulse light).

The first reception lens diameter φr (the aperture of the reception lens barrel 36) is larger than the diameter φs of the transmission lens 22 (the aperture of the transmission lens barrel 23) in order to improve the uptake amount of the reflected light PL3 and PL4 (reflected pulse light) reflected by the observation target object Ob and returning into the reception light visual field Sr. As a result, it is possible to receive the reflected light PL3 and PL4 (reflected pulse light) reflected by the observation target object Ob existing in the intended region and returning into the reception light visual field Sr.

Specifications of the first reception lens 31 are as described in the following table.

TABLE 3

| | |
|---|---|
| Lens diameter φs | 100 mm |
| Reception light viewing angle θr | 3 mrad (0.173°) to |
| | 5 mrad (0.286°) |
| Focal length f | Optional |
| Convergence angle θj | Optional |

The reception light viewing angle θr is set to be narrow (3 mrad (0.173°) to 5 mrad (0.286°) so that an intended region (a plane orthogonal to the optical axis) can be observed.

In a case where the lens diameter φr of the first reception lens 31 is 100 mm and the focal length f is 200 mm, a convergence angle θj (see FIG. 14) of the first reception lens 31 is about 14 degrees. This can be calculated from the equation tan (θj)=(φr/2)/f. On the other hand, in a case where the reception light viewing angle θr (see FIG. 14) is 3 mrad (0.173°) and the focal length f is 200 mm, a visual field image size Er is about 0.3 mm square. This can be calculated from the equation tan (θr)=(Er/2)/f.

Similarly to the transmission lens barrel 23, the reception lens barrel 36 is made of aluminum, and has an inner cylinder surface subjected to antireflection treatment. As a result, it is possible to absorb light incident on the reception lens 31 at a viewing angle other than the predetermined reception light viewing angle θr and prevent the light from reaching the light receiving element 35.

The field stop 32 is a light shielding stop that controls (narrows or widens) the reception light visual field Sr.

By providing the field stop 32 at the focal point (focal plane) of the first reception lens 31, the observation range (reception light visual field Sr) can be defined. For example, in the case of observing the wide reception light visual field Sr, the field stop 32 is opened, and conversely, in the case of observing only the narrow reception light visual field Sr, the field stop 32 is narrowed. As a result, the reception light visual field Sr can be adjusted.

Furthermore, in a case where the reception light viewing angle θr is constant, the visual field image of the focal plane can be reduced by shortening the focal length f of the first reception lens 31. Conversely, the visual field image of the focal plane can be increased by increasing the focal length f of the first reception lens 31.

The second reception lens 33 adjusts the visual field image of the focal plane to the size of the light receiving surface of the light receiving element 35. Note that the second reception lens 33 may be omitted in a case where it is unnecessary.

The reception filter 34 is a bandpass filter configured to transmit only reflected light (reflected pulse light) reflected by the observation target object Ob and returning into the reception light visual field Sr. In the first configuration example, a bandpass filter of 266 nm±5 nm (corresponding to the full width at half maximum of the deep ultraviolet LED 21) is used. By providing the reception filter 34, an S/N ratio of the signal (pulse electrical signal) corresponding to the reflected light (reflected pulse light) received by the reception unit 30, which is output by the reception unit 30 (light receiving element 35), is improved.

The light receiving element 35 is an ultraviolet photomultiplier tube (PMT) for photon counting. The PMT which is the light receiving element 35 of the first configuration example includes a high-voltage circuit necessary for an operation of the PMT and a preamplifier circuit which amplifies a pulse electrical signal photoelectrically converted by the PMT. Note that the light receiving element 35 may be a photoelectric conversion element for photon counting other than the PMT. The light receiving element 35 outputs a signal (pulse electrical signal) corresponding to the reflected light (reflected pulse light) received by the light receiving element 35.

The reception light visual field Sr is a circle obtained by adding the aperture or of the first reception lens 31 to a circle drawn by the reception light viewing angle θr centered on the optical axis AXr of the reception unit 30. In other words, the reception light visual field Sr is a circle of which the radius is a sum of the radius of the circle of the reception light viewing angle θr and the radius of the aperture φr of the first reception lens 31.

An optical axis AXs of the transmission unit 20 and an optical axis AXr of the reception unit 30 are disposed in a state of being separated from each other and being parallel to each other. A distance L1 (see FIG. 8) between the optical axis AXs of the transmission unit 20 and the optical axis AXr of the reception unit 30 is, for example, 85 mm. The distance L1 is preferably close to an aperture addition half value distance, which is a half value of the sum of the aperture of the transmission lens 22 of the transmission unit 20 and the aperture of the reception lens 31 of the reception unit 30, because the superimposition start distance r1 between the transmission light visual field Ss and the reception light visual field Sr is shortened. In general, the distance L1 is preferably about 1.05 to 1.1 times the aperture addition half value distance.

Also in the first configuration example, the transmission light visual field Ss and the reception light visual field Sr overlap each other (see the hatched region HT in FIG. 2 and the superimposed light visual field Sc in each cross-sectional view).

As a result, also in the first configuration example, since the reflected light (reflected pulse light) reflected by the observation target object Ob and returning into the reception light visual field Sr can be received, the observation target object Ob existing at a short distance (beyond the first position P1) can be observed. That is, observation data (LiDAR data) can be generated with high accuracy.

### <Second Configuration Example of Observation Apparatus 10>

Next, a specific second configuration example of the observation apparatus 10 will be described. Hereinafter, the observation apparatus 10 of the second configuration example will be referred to as an observation apparatus 10B.

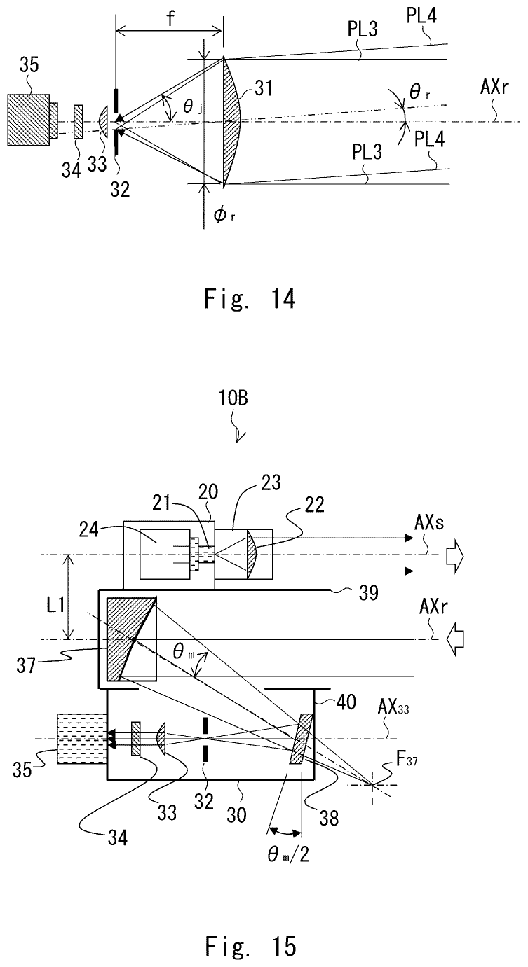

FIG. 15 is a schematic configuration diagram of the observation apparatus 10B.

The observation apparatus 10B is an observation apparatus (LiDAR apparatus) including a transmission unit 20 of a refractive system and a reception unit 30 of a reflective system.

As shown in FIG. 15, the observation apparatus 10B includes a transmission unit 20, a reception unit 30, and a control analysis unit 40 (not shown in FIG. 15). The optical axis AXs of the transmission unit 20 and the optical axis AXr of the reception unit are disposed to be separated from and parallel to each other.

### <Transmission Unit 20>

The transmission unit 20 includes a semiconductor light emitting element 21 and a transmission lens 22 (an example of a transmission optical system of the present disclosure).

The transmission unit 20 differs from the transmitter 20 of the first configuration example in specifications of the transmission lens 22. Specifications of the transmission lens 22 are as described in the following table.

TABLE 4

| Lens diameter φs | Φ25.4 mm (effective diameter |
|---|---|
| | φ25 mm) |
| Transmission light viewing angle θs | 25.99 mrad (≈26 mrad) |
| Focal length f | 20 mm |
| Uptake angle θi | 30° |

That is, the transmission lens 22 has a shorter focal length and a wider transmission light viewing angle θs than those of the transmission lens 22 of the first configuration example. As a result, even if the reception light aperture is increased, the transmission light visual field Ss can be overlapped with and included in the reception light visual field Sr at a short distance. Since the deep ultraviolet LED of 1.04 mm square is used, the transmission light viewing angle θs is 1.489° (25.99 mrad≈26 mrad). Other than that, the transmission unit 20 is similar to the transmission unit 20 of the first configuration example.

### <Reception Unit 30>

As shown in FIG. 15, the reception unit 30 is different from the reception unit 30 of the first configuration example in that a first reception mirror 37 and a second reception mirror 38 (an example of a reception optical system of the present disclosure) are provided instead of the first reception lens 31. Other than that, the reception unit 30 is similar to the reception unit 30 of the first configuration example. In FIG. 15, the reference numeral 39 denotes a reception main lens barrel, and the reference numeral 40 denotes a reception sub-lens barrel.

The first reception mirror 37 is a non-axial parabolic mirror (a peripheral portion of the parabolic mirror), and has a focal point F₃₇ outside the reception main lens barrel 39.

The second reception mirror 38 is disposed between the first reception mirror 37 and the focal point F₃₇ of the first reception mirror 37. The second reception mirror 38 is an example of a return mirror of the present disclosure.

Reflected light (reflected pulse light) reflected by the observation target object Ob and returning into the reception light visual field Sr is reflected by the first reception mirror 37 to be collected toward the focal point F37, further reflected by the second reception mirror 38, and guided to the light receiving element 35. In this manner, in the observation apparatus 10B, the transmission unit 20 and the reception unit 30 are separated. In addition, the second reception mirror 38 and the light receiving element 35 are provided outside an opening (an opening through which reception light is taken in) of the reception main lens barrel 39 of the reception unit 30. This prevents the reception light visual field Sr from being shielded in the observation distance region beyond the first position P1.

In the second configuration example, since an optical axis AXr (the center line of the first reception mirror 37) of the reception unit) 30 and an optical axis AX₃₃ (the center line of the light receiving element 35) of the second reception lens 33 are disposed in parallel, the second reception mirror 38 is inclined by ½ of an angle θm formed by the reflected light (light beam) reflected by the center of the first reception mirror 37 and the optical axis AX₃₃ of the second reception lens 33.

Similarly to the first configuration example, the reception light viewing angle θr is 3 mrad or 5 mrad.

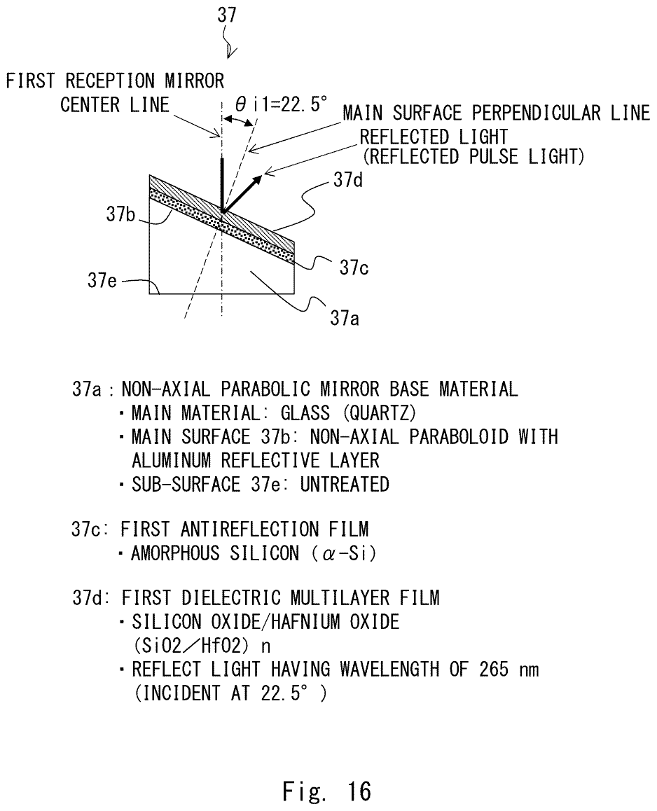

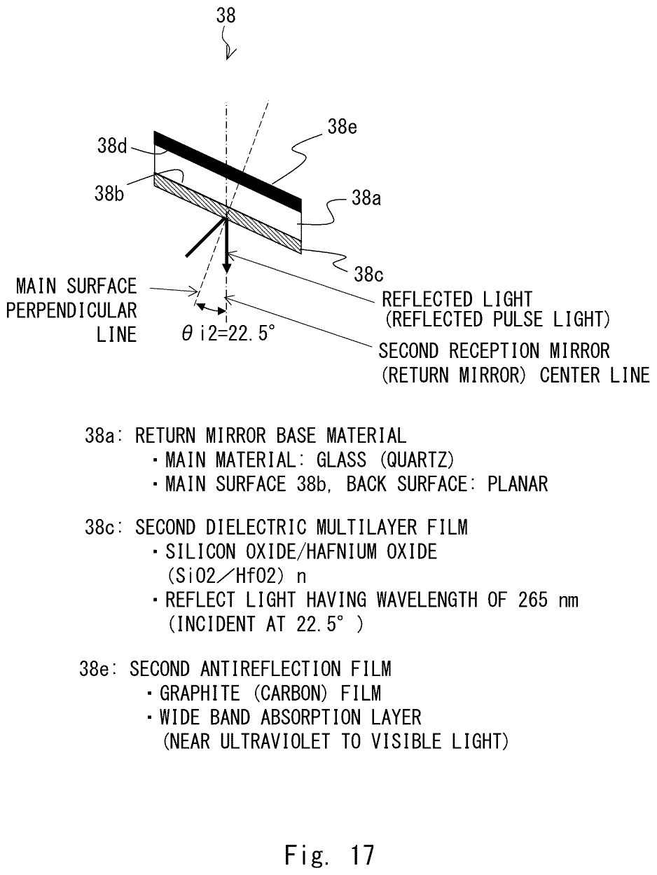

FIG. 16 is a cross-sectional view of the first reception mirror 37.

The first reception mirror 37 includes a non-axial parabolic mirror base material 37a having an aluminum-coated non-axial paraboloid as a main surface, an amorphous silicon (a-Si) first antireflection film 37c (an example of an antireflection member of the present disclosure) that is provided on the aluminum-coated surface of a main surface 37b and absorbs light in a near-ultraviolet to visible light band, and a first dielectric multilayer film 37d that is provided on the first antireflection film 37c and reflects light having a wavelength of 265 nm (incident at 22.5°), and is a mirror that reflects and collects light incident in parallel with an optical axis of the parabolic mirror of the original shape to a focal point F₃₇ of the parabolic mirror of the original shape.

Note that the various films and the disposition of the first reception mirror 37 may have the same configuration as that of the second reception mirror 38 that will be described later.

The non-axial parabolic mirror is a mirror in which an outer peripheral portion of the parabolic mirror is hollowed out, and a focal point (a focal point of a mirror of the original shape) is located outside the mirror.

The first antireflection film 37c is made of amorphous silicon (a-Si), titanium carbon nitride (TiCN), or diamond-like carbon (DLC), and is a layer that absorbs light in a near-ultraviolet to visible light band. In the second configuration example, the first antireflection film 37c has a function of absorbing light in a near-ultraviolet to visible light band transmitted through the first dielectric multilayer film 37d.

The first dielectric multilayer film 37d is a film in which thin films of silicon oxide (SiO₂) and hafnium oxide (hfO₂) are laminated in multiple layers, has a high reflectance (90% or more) with respect to light of deep ultraviolet 265 nm (incident angle) 22.5°, and transmits light in a near-ultraviolet to visible light band.

FIG. 17 is a cross-sectional view of the second reception mirror 38.

As shown in FIG. 17, the second reception mirror 38 includes a base material 38a (return mirror base material) of a flat plate, a second dielectric multilayer film 38c that reflects light having a wavelength of 265 nm (incident at 22.5°) on a main surface 38b, and a second antireflection film 38e (an example of an antireflection member of the present disclosure) of graphite (carbon) that absorbs light in a near-ultraviolet to visible light band on a sub surface 38d (back surface), and symmetrically reflects light incident on the main surface 38b.

The second antireflection film 38e is made of graphite, carbon, diamond-like carbon, or the like, and absorbs light transmitted through the second dielectric multilayer film 38c. In other words, light serving as a noise component other than observation purpose light (transmission light) is absorbed.

The second dielectric multilayer film 38c has the same configuration as that of the first dielectric multilayer film 37d.

Next, the reflectance of each reception mirror will be described.

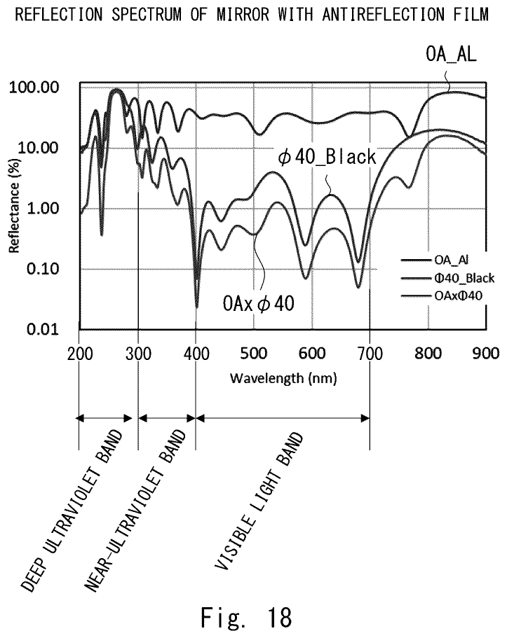

FIG. 18 shows a reflection spectrum of reflected light by each reception mirror.

Reflectance of 22.5° incident light was measured with respect to reflection surfaces of the first reception mirror 37 (non-axial parabolic mirror) and the second reception mirror 38 (return mirror). In FIG. 13, the horizontal axis represents a wavelength, and the vertical axis represents reflectance (%).

In FIG. 18, “OA_A1” represents a reflection spectrum of the first reception mirror 37 in which the first antireflection film 37c and the first dielectric multi-layer film 37d are provided on the main surface 37b of the non-axial parabolic mirror base material 37a with an aluminum layer. The configuration of the first reception mirror 37 is as described in the following table.

TABLE 5

| | |
|---|---|
| Configuration | Base material (glass/aluminum layer)/first |
| | antireflection film/first dielectric multilayer |
| | film layer |
| First antireflection | Amorphous silicon (α-Si) |
| film | |
| First dielectric | {Silicon oxide (SiO2)/hafnium oxide (HfO2)}n |
| multilayer film | |
| Deposition | Sputtering method |

In FIG. 18, “Φ40_Black” represents a reflection spectrum of the second reception mirror 38 in which the second dielectric multilayer film 38c is provided on the main surface 38b of the return mirror base material 38a and the second antireflection film 38e is provided on the sub-surface 38d (back surface).

The configuration of the second reception mirror 38 is as described in the following table.

TABLE 6

| | |
|---|---|
| Configuration | Second dielectric multilayer film/substrate |
| | (glass)/second antireflection film |
| Second | Graphite film |
| antireflection film | |
| Second dielectric | {Silicon oxide (SiO2)/hafnium oxide (HfO2)}n |
| multilayer film | |
| Deposition | Sputtering method |

In FIG. 18, “OAxφ40” represents a product (total reflectance spectrum) of the reflectances of the first reception mirror 37 and the second reception mirror 38.

Next, functions, operations, and effects of the antireflection film will be described.

The reflectance in the deep ultraviolet band, particularly the reflectance product of the transmission light wavelength at 265 nm is as high as 90% or more.

On the other hand, the reflectance product of light in the near-ultraviolet band of 300 nm to 400 nm is reduced to 1/10 or less, and the reflectance in the visible light band of 400 nm to 700 nm is reduced to 1/100 or less.

As described above, by providing the antireflection film layer on the first reception mirror 37 and the second reception mirror 38, noise light can be removed before being incident on the light receiving element 35. This makes it possible to suppress the influence of sunlight particularly in daytime observation. The light receiving element 35 for photon counting has high reception sensitivity. Therefore, light having a wavelength other than the light receiving target wavelength (wavelength of 265 nm) can be removed before reaching the light receiving element 35. As a result, noise can be suppressed, and highly accurate observation can be performed.

Next, an example of performing automatic deviation calibration and target object measurement by using the observation apparatus 10 having the above configuration will be described. FIG. 19 shows an example of an environment in which automatic deviation calibration and target object measurement are performed. Hereinafter, as shown in FIG. 19, a case where the target object Ob (here, an exhaust gas discharged from a chimney) is measured will be described as an example. Automatic deviation calibration and target object measurement are performed in this order. Note that automatic deviation calibration and target object measurement may be performed by using a general observation apparatus other than the observation apparatus 10. In this case, the general observation apparatus may be an observation apparatus that transmits and receives laser light.

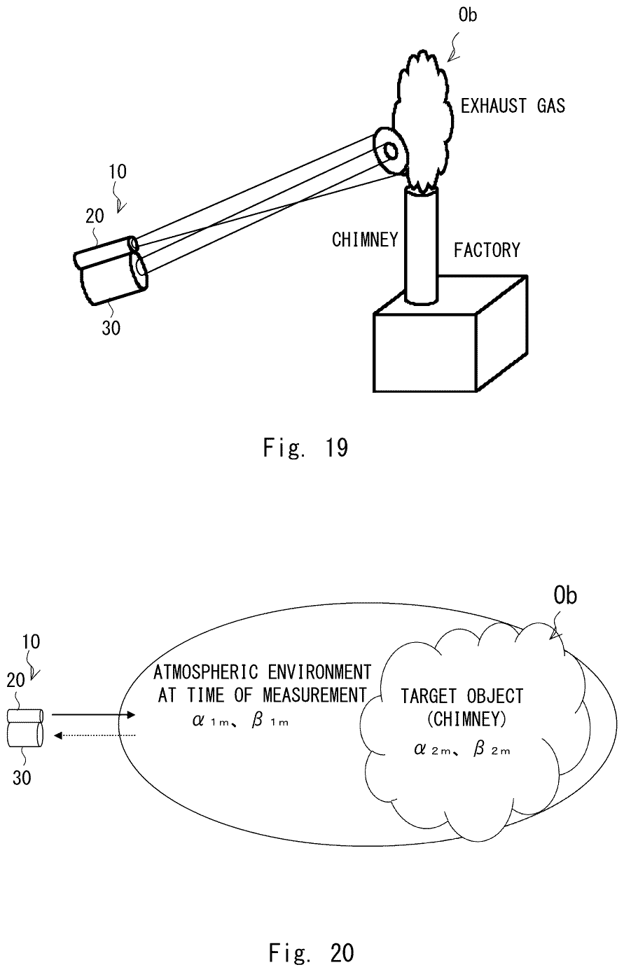

FIG. 20 shows an example of an environment in which target object measurement is performed.

First, as shown in FIG. 20, the dissipation coefficient of the atmosphere (atmosphere at the time of measurement) before the target object Ob is α₁ₘ, the backscattering coefficient thereof is β₁ₘ, and the dissipation coefficient of the target object Ob is α₂ₘ, and the backscattering coefficient thereof is β₂ₘ.

Here, since the dissipation coefficient α₁ₘ and the backscattering coefficient β₁ₘ include an apparatus deviation (a value (real number) unique to the observation apparatus 10), the dissipation coefficient α₁ₘ and the backscattering coefficient β₁ₘ are expressed by the following Formulas A and B.

$${α}_{1 m} = {α}_{1 t} \times {K}_{α} \qquad ( Formula A )$$

$${β}_{1 m} = {β}_{1 t} \times {K}_{β} \qquad ( Formula B )$$

Here, α₁ₜ represents a true dissipation coefficient of the atmospheric environment (the atmospheric environment at the time of measurement), and K_{α} represents an apparatus deviation of the dissipation coefficient. On the other hand, β₁ₜ represents a true backscattering coefficient of the atmospheric environment (the atmospheric environment at the time of measurement), and K_{β} represents an apparatus deviation of the backscattering coefficient. The apparatus deviations Kα and Kβ are calculated through automatic deviation calibration processing that will be described later.

On the other hand, the dissipation coefficient α₂ₘ and the backscattering coefficient β₂ₘ of the region where the target object is present include the influence of the atmospheric environment, and are thus expressed by the following Formulas C and D.

$${α}_{2 m} = {α}_{1 m} + {α}_{2} \qquad ( Formula C )$$

$${β}_{2 m} = {β}_{1 m} + {β}_{2} \qquad ( Formula D )$$

However, the dissipation coefficient α₂ and the backscattering coefficient β₂ also include apparatus deviations, and are thus expressed by the following Formulas E and F.

$${α}_{2} = {α}_{2 t} \times {K}_{α} \qquad ( Formula E )$$

$${β}_{2} = {β}_{2 t} \times {K}_{β} \qquad ( Formula F )$$

Here, α₂ₜ represents a true dissipation coefficient of the target object Ob, and K_{α} represents an apparatus deviation of the dissipation coefficient. On the other hand, β₂ₜ represents the true backscattering coefficient of the target object Ob, and K_{β} represents an apparatus deviation of the backscattering coefficient. The true dissipation coefficient α₂ₜ of the target object Ob and the true backscattering coefficient β₂ₜ of the target object Ob are calculated through target object measurement processing that will be described later.

The apparatus deviations K_{α} and K_{β} can be calculated as follows.

### <Automatic Deviation Calibration>

The apparatus deviations K_{α} and K_{β} can be calculated as follows by using the LiDAR equation, the dissipation coefficient of the standard atmosphere, and the backscattering coefficient of the standard atmosphere.

That is, as described above, the LiDAR equation is expressed by the following Formula G.

$$[ Math . 2 ]$$

$$P ( R ) = {P}_{0} Y ( R ) C \frac{β ( R )}{{R}^{2}} exp [ - 2 {\int }_{0}^{R} α ( R ) dr ] \qquad ( Formula G )$$

Here, R is a distance, P is a reception light intensity, Po is a transmission light output, Y is a geometric efficiency factor, C is a device constant, β is a backscattering coefficient, and α is a dissipation coefficient (absorption+diffusion). In addition, P(R), Y(R), β(R), and α(R) respectively represent an intensity, a factor, and coefficients at the distance R. In addition, r is an elapsed distance up to the distance R.

Here, in a case where it is assumed that the aerosols in the atmosphere are uniformly dispersed, since α(R) and β(R) are constant values α and β that do not depend on the distance R, the above Formula G is expressed by the following Formula H.

$$[ Math . 3 ]$$

$$P ( R ) = {P}_{0} Y ( R ) C \frac{β ( R )}{{R}^{2}} exp [ - 2 α R ] \qquad ( Formula H )$$

Next, both sides of the above Formula H are multiplied by the distance R² to perform distance attenuation correction, and divided by the coupling efficiency Y(R) to take a logarithm, thereby obtaining the following Formula I.

$$[ Math . 4 ]$$

$$\begin{matrix}ln ( P ( R ) {R}^{2} / Y ( R ) ) = ln ( {P}_{0} C β exp [ - 2 α R ] ) \\ = ln ( {P}_{0} C β ) - 2 α R \\ = - 2 α R + ln ( {P}_{o} C β )\end{matrix} \qquad ( Formula I )$$

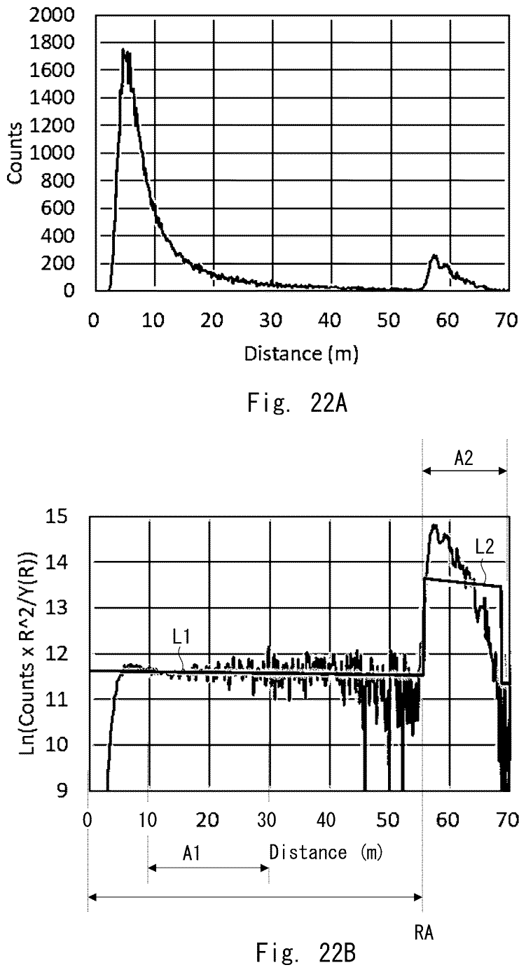

This Formula I represents a straight line having a slope of −2α and an intercept of ln(P₀Cβ) on the coordinate (see, for example, FIG. 22B) in which the vertical axis is ln(P(R)R2/Y(R)) and the horizontal axis is R.

Here, the dissipation coefficient α and the backscattering coefficient β include apparatus deviations, and are thus expressed by the following Formula J and Formula K.

$$α = {α}_{t} \times {K}_{α} \qquad ( Formula J )$$

$${P}_{0} C β = {β}_{t} \times {K}_{β} \qquad ( Formula K )$$

Here, at represents a true dissipation coefficient of the atmospheric environment (the atmospheric environment at the time of measurement), and K_{α} represents an apparatus deviation. On the other hand, βₜ represents a true backscattering coefficient of the atmospheric environment (the atmospheric environment at the time of measurement), and K_{β} represents an apparatus deviation.

Based on the above description, automatic deviation calibration processing for calculating the apparatus deviations K_{α} and K_{β} will be described.

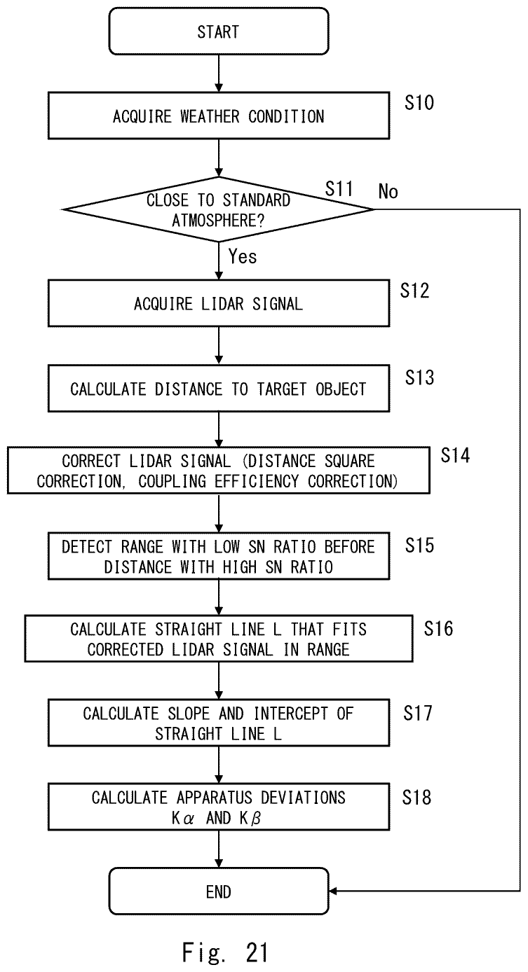

FIG. 21 is a flowchart of automatic deviation calibration processing for calculating the apparatus deviations K_{α} and K_{β}. The processing in FIG. 21 is started, for example, when an operator performs a predetermined operation on the observation apparatus 10 (for example, a calibration start switch is turned on). Although not shown, when the operator performs a predetermined operation on the observation apparatus 10, the observation apparatus 10 (processor) executes a predetermined program read from a storage unit (for example, a ROM) into a memory (for example, a RAM), thereby executing each process (steps S10 to S18) in FIG. 21.

First, a weather condition is acquired (step S10). The weather condition is data (weather data) representing a weather condition (for example, the presence or absence of rainfall and the presence or absence of fog) of a measurement position (a position where the observation apparatus 10 is located) at the time of measurement. The weather condition may be acquired from the outside of the observation apparatus 10 by communication, or may be acquired from a weather sensor (not shown) attached to the observation apparatus 10.

Next, it is determined whether the atmosphere of the measurement position is close to the standard atmosphere (step S11). This is determined, for example, by comparing the weather condition acquired in step S10 with the weather condition of the standard atmosphere stored in advance. By providing step S11, it is possible to prevent automatic deviation calibration from being performed in a weather condition unsuitable for automatic deviation calibration, such as when it rains or is foggy.

Next, a LiDAR signal is acquired (step S12). Specifically, an atmospheric echo of the atmospheric environment (an atmospheric environment substantially the same as the standard atmosphere) of the measurement position (a position where the observation apparatus 10 is located) is measured by performing a process of generating observation data (LiDAR data) (see FIG. 7) by using the observation apparatus 10. FIG. 22A shows an example of the acquired LiDAR signal.

Next, a distance to the target object is calculated on the basis of the LiDAR signal acquired in step S12 (step S13). Here, as shown in FIG. 22B, it is assumed that a distance RA is calculated as the distance to the target object.

Next, the LiDAR signal acquired in step S12 is corrected (distance square correction and coupling efficiency correction) (step S14). FIG. 22B shows an example of the corrected LiDAR signal.

Next, a range with a low SN ratio before a distance with a high SN ratio is detected (step S15). Here, it is assumed that a range A1 of a distance of 10 m to 30 m (see FIG. 22B) with a small fluctuation range before a distance RA is detected as a range with a low SN ratio.

Next, a straight line L that fits the corrected LiDAR signal in the range detected in step S15 (here, the range A1) is calculated by using the least squares method (step S16).

Next, a slope and an intercept of the straight line L calculated in step S16 are calculated (step S17). Here, it is assumed that the slope of −2α=−0.00168 and the intercept of ln(P₀Cβ)=11.62 of the straight line L are calculated.

Next, the apparatus deviations K_{α} and K_{β} are calculated (step S18).

Specifically, the apparatus deviation K_{α} is calculated as follows. First, by using the above Formula J, the slope of the straight line L is obtained as follows. −2α=−2×αₜ×K_{α}=−0.00168 . . . (Formula L) Here, since the atmospheric echo in the atmospheric environment substantially the same as that of the standard atmosphere was measured, αₜ is obtained as follows. αₜ=the dissipation coefficient of the standard atmosphere α=1.70×10⁻⁴ m⁻¹ . . . (Formula M) Note that the standard atmospheric dissipation coefficient α=1.70×10⁻⁴ m⁻¹ was quoted from Journal of the remote sensing society of Japan, Vol. 38, No. 4 (2018), pp 317 to 324, Shiina et al., “Development of Rover Mounting LED LiDAR and Observation of Dust Behavior”. The same applies to a standard atmospheric backscattering coefficient β=3.40×10⁻⁶ m⁻¹ sr⁻¹ that will be described later.

According to the above Formulas L and M, the apparatus deviation K_{α}=4.94 can be calculated.

On the other hand, the apparatus deviation K_{β} is calculated as follows. First, by using the above Formula K, the intercept of the straight line L is obtained as follows. ln(P₀Cβ)=ln(βₜ×K_{β})=11.62 . . . (Formula N) Here, since the atmospheric echo in the atmospheric environment substantially the same as that of the standard atmosphere was measured, βₜ is obtained as follows. βₜ=the backscattering coefficient β of the standard atmosphere=3.40×10⁻⁶ m⁻¹ sr⁻¹ . . . (Formula O).

According to the above Formulas N and O, the apparatus deviation K_{β}=3.27×10¹⁰ can be calculated.

As described above, according to the automatic deviation calibration processing, the apparatus deviation K_{α} of the dissipation coefficient and the apparatus deviation K_{β} of the backscattering coefficient, which are the deviations (calibration values) of the observation apparatus 10 for calculating the true dissipation coefficient α₂ₜ and the true backscattering coefficient β₂ₜ of the target object Ob (measurement target object), can be calculated. In this case, the apparatus deviations K_{α} and K_{β} are calculated by using the LiDAR signal of the atmosphere before the target object Ob (here, the corrected LiDAR signal in the range A1 shown in FIG. 22B), and can thus be easily calculated. The calculated apparatus deviations K_{α} and K_{β} are stored in a storage unit (not shown) of the observation apparatus 10 and used at the time of target object measurement that will be described later.

### <Target Object Measurement>

Next, target object measurement processing for calculating the true dissipation coefficient α₂ₜ and the true backscattering coefficient β₂ₜ of the target object Ob will be described. Hereinafter, as a premise, it is assumed that the apparatus deviation K_{α}=4.94 and the apparatus deviation K_{β}=3.27×10¹⁰ are calculated in advance through the automatic deviation calibration processing and stored in the storage unit (not shown) of the observation apparatus 10. The automatic deviation calibration processing may be performed every time before the target object measurement processing, or need not be performed every time before the target object measurement processing. For example, the automatic deviation calibration processing may be performed every time the target object measurement processing is performed a plurality of times (or every time a predetermined period elapses).

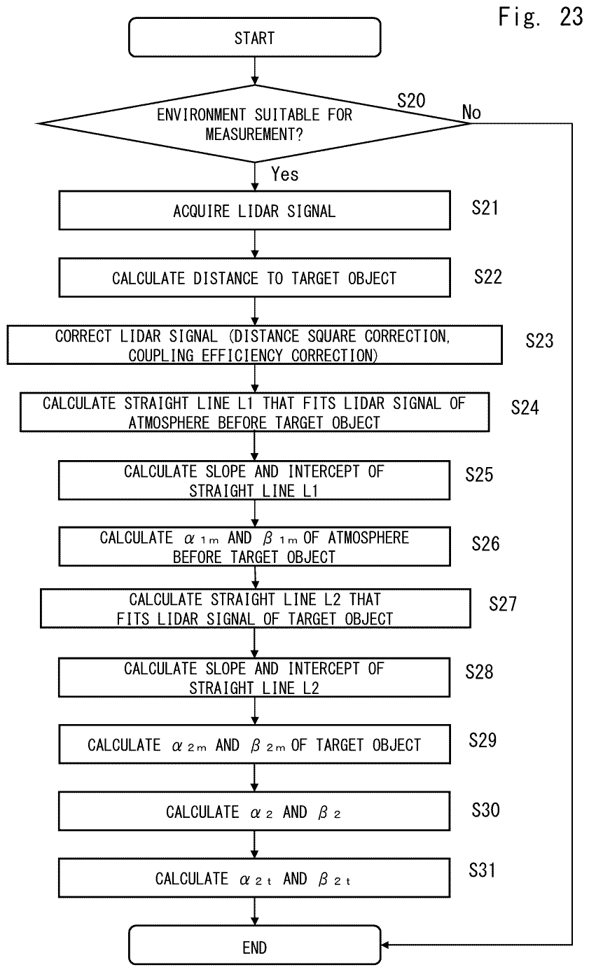

FIG. 23 is a flowchart showing the target object measurement processing. The processing in FIG. 23 is automatically executed after the processing in FIG. 21 ends. Although not shown, after the processing in FIG. 21 ends, the observation apparatus 10 (processor) executes a predetermined program read from the storage unit (for example, a ROM) into the memory (for example, a RAM), thereby executing each process (steps S20 to S31) in FIG. 23. Note that the processing in FIG. 23 may be started, for example, when an operator performs a predetermined operation on the observation apparatus 10 (for example, a target object measurement start switch is turned on).

First, it is determined whether the environment is suitable for measurement (step S20). For example, in a case where an environment (here, a chimney) suitable for measurement can be recognized by a camera (or the naked eye) provided in the observation apparatus 10, the environment is determined to be suitable for observation.

Next, in a case where it is determined that the environment is suitable for measurement (step S20: YES), a LiDAR signal is acquired (step S21). Specifically, by performing observation data (LiDAR data) generation processing (see FIG. 7) using the observation apparatus 10, an atmospheric echo of the atmospheric environment (the atmospheric environment substantially the same as the standard atmosphere) of the measurement position (the position where the observation apparatus 10 is located) at the time of measurement is measured. FIG. 22A shows an example of the acquired LiDAR signal.

Next, the distance RA to the target object Ob (here, an exhaust gas discharged from the chimney) and the distance RB to the depth of the target object are calculated on the basis of the LiDAR signal acquired in step S21 (step S22).

Next, the LiDAR signal acquired in step S21 is corrected (distance square correction and coupling efficiency correction) (step S23). The corrected signal intensity is expressed by the following Formula P and the graph shown in FIG. 22B. FIG. 22B shows an example of the corrected LiDAR signal.

$$[ Math . 5 ]$$

$$\begin{matrix}ln ( P ( R ) {R}^{2} / Y ( R ) ) = ln ( {P}_{0} c β ( R ) exp [ - 2 {\int }_{0}^{R} α ( r ) dr ] ) \\ = ln ( 3.27 \times {10}^{10} \times {β}_{t} ( R ) exp [ - 2 {\int }_{0}^{R} 4.94 \times {α}_{t} ( r ) dr ] )\end{matrix} \qquad ( Formula P )$$

Based on this Formula P (the graph shown in FIG. 22B), it can be seen that the target object Ob (here, the exhaust gas discharged from the chimney) is in a range A2 of 55 m (RA) to 68 m (RB) where the atmospheric echo becomes large.

Next, the straight line L1 (see FIG. 22B) that fits the LiDAR signal of the atmosphere before the target object Ob is calculated by using the least squares method (step S24).

Next, a slope and an intercept of the straight line L1 calculated in step S24 are calculated (step S25).

Next, the dissipation coefficient dim and the backscattering coefficient β₁ₘ of the atmosphere before the target object Ob are calculated (step S26). Specifically, since the slope of the straight line L1 can be represented by −2α₁ₘ, α₁ₘ can be calculated on the basis of this relationship. On the other hand, since the intercept of the straight line L1 can be represented by ln(P₀Cβ₁ₘ), β₁ₘ can be calculated on the basis of this relationship.

Next, a straight line L2 that fits the LiDAR signal of the target object Ob is calculated by using the least squares method (step S27).

Next, a slope and an intercept of the straight line L2 calculated in step S27 are calculated (step S28).

Next, the dissipation coefficient α₂ₘ and the backscattering coefficient β₂ₘ of the target object Ob are calculated (step S29). Specifically, since the slope of the straight line L2 can be represented by −2α₂ₘ, α₂ₘ can be calculated on the basis of this relationship. On the other hand, since the intercept of the straight line L2 can be represented by ln(P₀Cβ₂ₘ), β₂ₘ can be calculated on the basis of this relationship.

Next, α₂ and β₂ are calculated (step S30). α₂ can be calculated on the basis of the above Formula C. On the other hand, β₂ can be calculated on the basis of the above Formula D.

Next, the true dissipation coefficient α₂ₜ and the true backscattering coefficient β₂ₜ of the target object Ob are calculated (step S31). α₂ₜ can be calculated on the basis of the above Formula E. On the other hand, β₂ₜ can be calculated on the basis of the above Formula F.

As described above, according to the target object measurement processing, the true dissipation coefficient α₂ₜ and the true backscattering coefficient β₂ₜ of the target object Ob (measurement target object) can be calculated. For example, in the case of the graph shown in FIG. 22B, the true dissipation coefficient α₂ₜ=1.41e-3 of the target object Ob and the true backscattering coefficient β₂ₜ=2.81e-5 of the target object Ob can be calculated. That is, it can be seen that there is the target object Ob (here, the exhaust gas discharged from the chimney) having the true dissipation coefficient α₂ₜ=1.41e-3 and the true backscattering coefficient β₂ₜ=2.81e-5 in the range A2 of 55 m to 68 m where the atmospheric echo becomes large.

In a general sensor, the measurable dissipation coefficient α of the target object is about 0.05, whereas in the observation apparatus 10 of the present embodiment, the measurable dissipation coefficient of the target object is 1.41e-3. This indicates that the sensitivity of the observation apparatus 10 is very high (that smoke having a very low concentration can be measured) compared with a general sensor.

In addition, according to the present embodiment, deviation (calibration value) correction can be automatically performed before measurement, and the true dissipation coefficient and the true backscattering coefficient of the target object can be quickly calculated.

According to the present embodiment, the concentration of the target can be obtained from these values, the true dissipation coefficient αₜ and the true backscattering coefficient βₜ of smoke, dust, or the like at a specified concentration.

Next, automatic adjustment of the transmission optical axis angle (the transmission optical axis AXs of the transmission light visual field) will be described. Three pieces of automatic adjustment means including first to third automatic adjustment of the transmission optical axis angle will be described below. The automatic adjustment of the transmission optical axis angle is executed by the control analysis unit.

Hereinafter, as a premise, it is assumed that the observation apparatus 10 configured to be able to adjust the transmission optical axis angle θc is used. A configuration capable of adjusting the transmission optical axis angle θc will be described later.

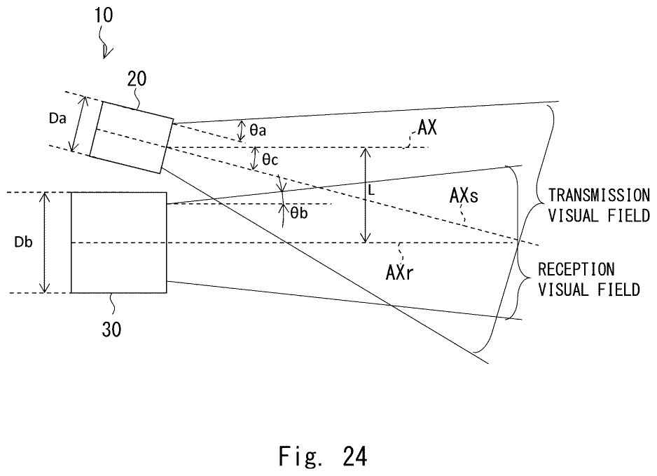

First, parameters used for automatic adjustment of the transmission optical axis angle will be described. FIG. 24 shows examples of parameters used for the automatic adjustment of the transmission optical axis angle. The reference numerals in FIG. 24 have the following meanings.

In a case where the transmission optical axis angle θc is adjusted by rotating the transmission unit 20 around the center of the transmission port, L is a distance from the center of the transmission port to the reception optical axis. In this case, L does not change regardless of the adjustment of the transmission optical axis angle θc. The meanings of the other parameters are as follows. Da: transmission diameter (transmission visual field diameter at the transmission port when transmission and reception optical axes are not parallel), Db: reception diameter, θa: transmission spread angle, θb: reception spread angle, θc: transmission optical axis angle The angle between the transmission optical axis AXs of the transmission light visual field and the reception optical axis AXr (axis AX parallel thereto) of the reception light visual field is the transmission optical axis angle θc.

### <First Automatic Adjustment of Transmission Optical Axis Angle>

First, first automatic adjustment of the transmission optical axis angle will be described.

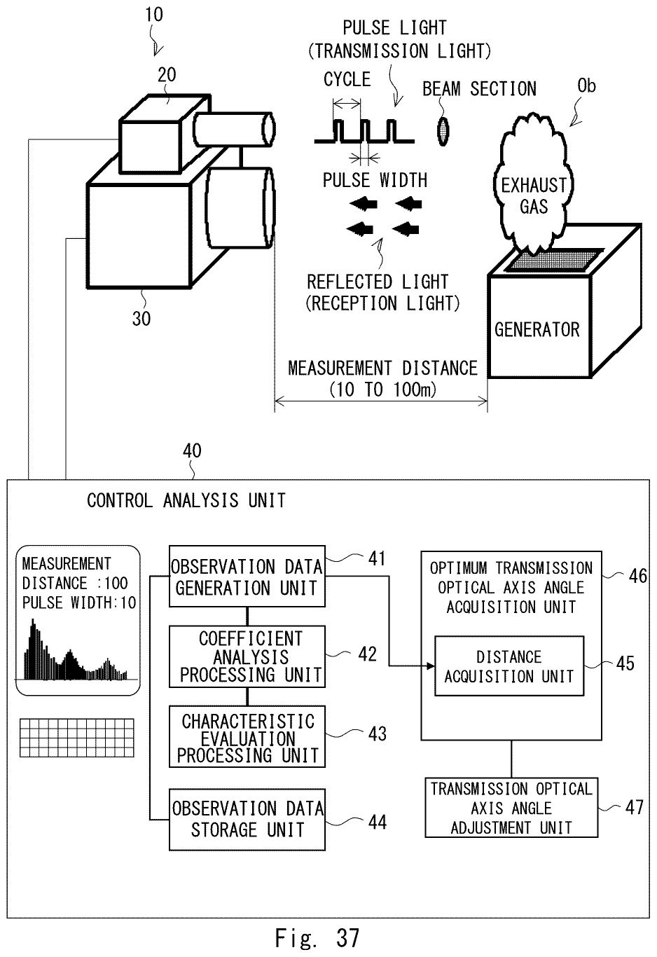

FIG. 37 is a schematic configuration diagram of the observation apparatus 10 used in the first automatic adjustment of the transmission optical axis angle.

In the first automatic adjustment of the transmission optical axis angle, as shown in FIG. 37, the control analysis unit 40 includes a distance acquisition unit 45, an optimum transmission optical axis angle acquisition unit 46, and a transmission optical axis angle adjustment unit 47 in addition to the observation data generation unit 41, the coefficient analysis processing unit 42, the characteristic evaluation processing unit 43, and the observation data storage unit 44. Although not shown, these units are realized by the processor executing a predetermined program read from the storage unit (for example, a ROM) into the memory (for example, a RAM). Some or all of the units may be realized by hardware.

The distance acquisition unit 45 acquires a distance to an observation target object.

The optimum transmission optical axis angle acquisition unit 46 acquires the optimum transmission optical axis angle that is a transmission optical axis angle at which the coupling efficiency is maximized at the distance acquired by the distance acquisition unit 45 in a case where coupling efficiency is the area of the superimposed region of the transmission light visual field and the reception light visual field/the area of the transmission light visual field, and the angle between the transmission optical axis of the transmission light visual field and the reception optical axis of the reception light visual field is the transmission optical axis angle θc.

The transmission optical axis angle adjustment unit 47 adjusts the transmission optical axis angle θc of the transmission unit 20 to the optimum transmission optical axis angle acquired by the optimum transmission optical axis angle acquisition unit 46.

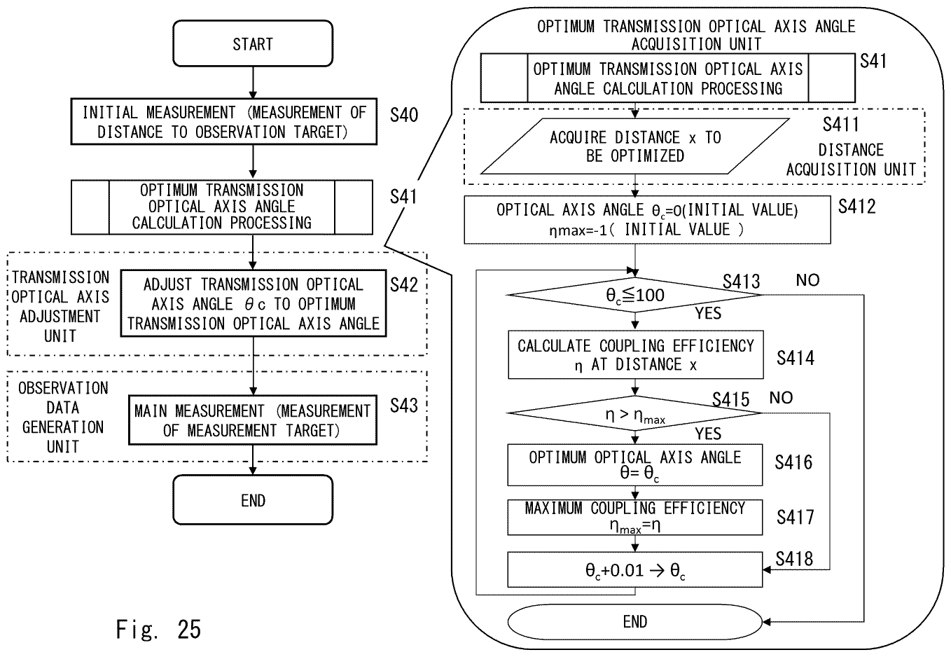

FIG. 25 is a flowchart showing the first automatic adjustment of the transmission optical axis angle. The processing in FIG. 25 is started, for example, when an operator performs a predetermined operation on the observation apparatus 10 (for example, an automatic adjustment start switch for the transmission optical axis angle is turned on). Although not shown, when the operator performs a predetermined operation on the observation apparatus 10, the observation apparatus 10 (processor) executes a predetermined program read from the storage unit (for example, a ROM) into the memory (for example, a RAM), thereby executing each process (steps S40 to S43) in FIG. 25.

Hereinafter, it is assumed that L (transmission/reception optical axis distance) is 85 mm, Da (transmission diameter) is 60 mm, Db (reception diameter) is 100 mm, θa (transmission spread angle) is 10 mrad, θb (reception spread angle)=5 mrad, θc (transmission optical axis angle) is variable (adjustment target), and an initial condition is 5.88 mrad (a condition that an average coupling efficiency in a range of 1 to 100 m is maximized).

First, as initial measurement, distance measurement of an observation target is performed (step S40). This is realized by the distance acquisition unit 45. For example, in a case where an observation target can appear anywhere within the measurement range of 1 to 100 m, in order to first find the observation target in the initial measurement, a distance to the observation target is measured in a state in which the transmission optical axis angle θc (for example, θc=5.588 mrad) is set to achieve coupling efficiency suitable for measurement in a wide range, for example, a range of about 100 m.

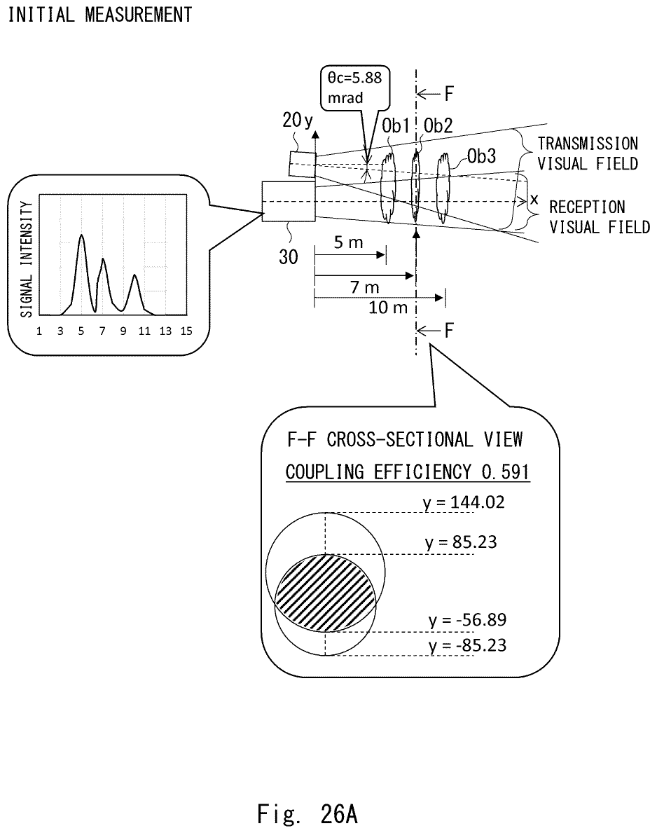

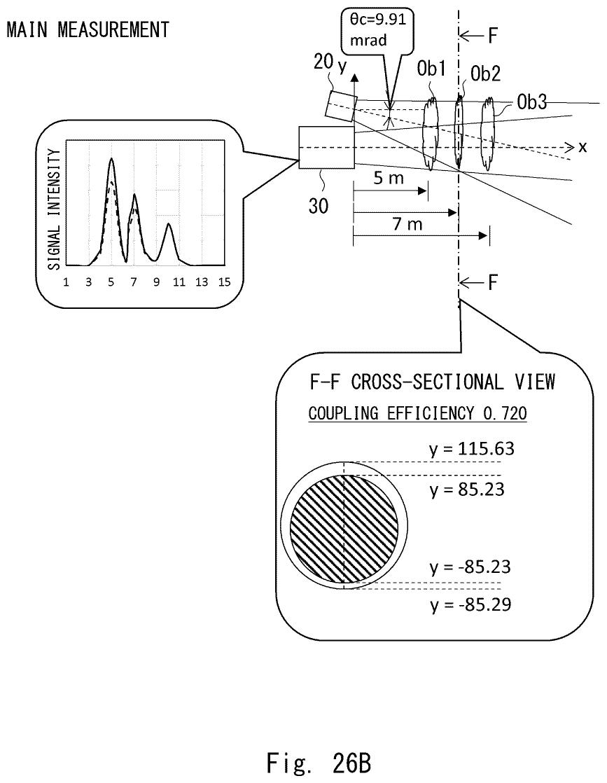

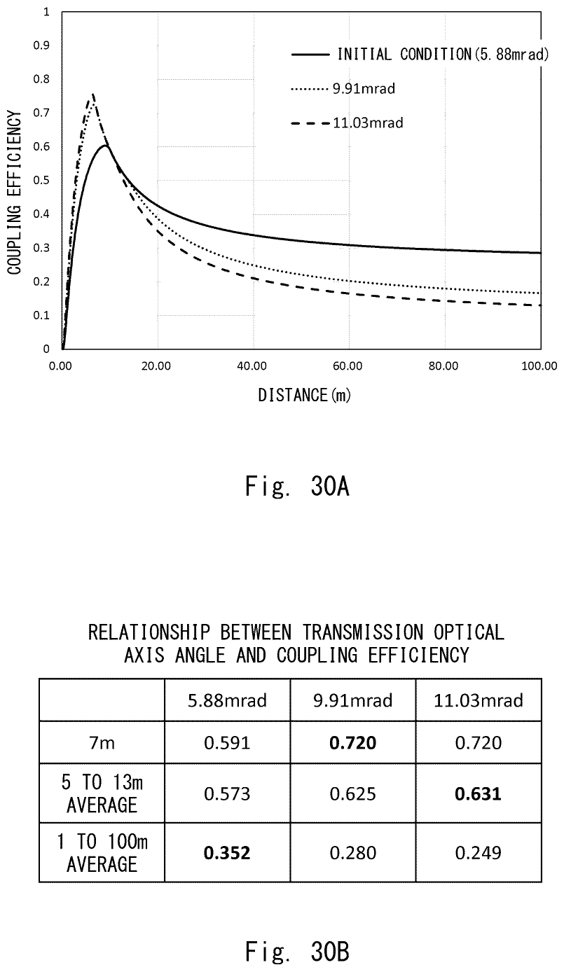

FIG. 26A is a diagram for describing initial measurement of the first automatic adjustment of the transmission optical axis angle, and FIG. 26B is a diagram for describing main measurement. Here, it is assumed that, as a result of the measurement in step 40, pieces of smoke Ob1, Ob2, and Ob3 that are observation targets are found at 5 m, 7 m, and 10 m, respectively, as shown in FIG. 26A. It is assumed that it is desired to determine the property of the smoke Ob2 existing at 7 m. In this case, since the coupling efficiency in the initial measurement is set with emphasis on taking the range of 1 to 100 m in the visual field, the coupling efficiency at 7 m and the transmission optical axis angle θc=5.588 mrad is low, for example, 0.591 (see “F-F cross-sectional view” in FIG. 26A). The transmission optical axis angle θc (for example, θc=5.588 mrad) in the initial setting is the initial measurement angle of the present disclosure, and one stored in advance in the storage unit (not shown) may be used, or one input or selected by the operator may be used. Here, the coupling efficiency is calculated by using the above Formula 1. In the above Formula 1, the visual field coupling ratio Cr represents the coupling efficiency. The coupling efficiency changes according to the distance to the observation target and the transmission optical axis angle θc (See FIGS. 30A and 30B). FIG. 30A is a graph showing coupling efficiency such as an initial condition, and FIG. 30B is a table showing a relationship between a transmission optical axis angle and coupling efficiency.

Next, optimum transmission optical axis angle calculation processing is executed (step S41). This is realized by the optimum transmission optical axis angle acquisition unit 46. The optimum transmission optical axis angle calculation processing is processing of calculating (acquiring) the optimum transmission optical axis angle at which the coupling efficiency is maximized at the distance to the observation target (here, the distance of 7 m to the smoke Ob2 measured in step 40). The optimum transmission optical axis angle calculation processing will be described later. Here, it is assumed that 9.91 mrad is calculated (acquired) as the optimum transmission optical axis angle as a result of step S41. Step S41 is an example of an optimum transmission optical axis angle acquisition unit of the present disclosure.

Next, the transmission optical axis angle θc is adjusted (set) to the optimum transmission optical axis angle=9.91 mrad (the main measurement angle of the present disclosure) calculated in step S41 (step S42). This is realized by the transmission optical axis angle adjustment unit 47. Step S42 is an example of a transmission optical axis adjustment unit of the present disclosure.

Next, as the main measurement, the observation target is measured in a state in which the transmission optical axis angle is adjusted to the optimum transmission optical axis angle calculated in step S41 (step S43). Specifically, after adjusting the transmission optical axis angle θc to the optimum transmission optical axis angle, the observation data generation unit 41 generates LiDAR data that is observation data on the basis of a signal output from the light receiving element 35. The generated LiDAR data is stored in a built-in or external storage unit (not shown) accessible by the observation apparatus 10 (processor). Here, in order to determine the property of the smoke Ob2 existing at 7 m, the smoke Ob2 existing at 7 m is measured in a state in which the transmission optical axis angle θc is adjusted to the optimum transmission optical axis angle=9.91 mrad calculated in step S41. In this case, since it is most important to see the smoke Ob2 existing at 7 m, the coupling efficiency in the main measurement, that is, the coupling efficiency at 7 m and the transmission optical axis angle θc=9.91 mrad is higher than the coupling efficiency “0.591” in the initial measurement, for example, 0.720 (see “F-F cross-sectional view” in FIG. 26B).

In a case where the measurement of the observation target is performed in a state in which the transmission optical axis angle is adjusted to the optimum transmission optical axis angle as described above, the signal intensity of the reflected light (reflected pulse light) reflected by the observation target and returning into the reception light visual field is also maximized, Y(R) in the LiDAR equation increases, and P(R) in the LiDAR equation also increases. On the other hand, even if the transmission optical axis angle θc is adjusted to maximize the coupling efficiency at the distance to the observation target, the coupling efficiency does not affect a noise component (electrical noise, diffuse reflection noise, and ambient light noise derived from the apparatus). As a result, an S/N ratio of the signal (the output signal of the light receiving element 35) obtained from the observation target (here, the smoke Ob2 existing at 7 m) is improved. Since the S/N ratio is improved as described above, not only the distance to the observation target but also the property determination of the observation target (here, the smoke Ob2 existing at 7 m) that requires more detailed information such as an intensity of the signal from the observation target can be easily performed. For example, it is possible to determine the properties of more targets.

Next, the optimum transmission optical axis angle calculation processing in step S41 will be described.

Steps S411 to S418 in FIG. 25 are an example of a flowchart showing the optimum transmission optical axis angle calculation processing in step S41. The processes in steps S411 to S418 are executed by the observation apparatus 10 (processor) executing a predetermined program read from the storage unit (for example, a ROM) into the memory (for example, a RAM).

First, a distance x to be optimized is acquired (step S411). This is realized by the distance acquisition unit 45. For example, the distance acquisition unit 45 acquires a distance of 7 m to the smoke Ob2 measured in step S40 as the distance x to be optimized. Step S411 is an example of a distance acquisition unit of the present disclosure. For example, the distance acquisition unit 45 extracts the distance of the target object from the observation data (distance data) generated by the observation data generation unit 41 of the control analysis unit 40 in the initial measurement.

Next, optical axis angles θ_{c} and ηmax as variables are respectively set to 0 and −1 as initial values (step S412).

Next, it is determined whether or not the optical axis angle θ_{c}≤100 is satisfied (step S413), and in a case where the optical axis angle θ_{c}≤100 is satisfied (step S413: YES), the coupling efficiency η at the distance x is calculated (step S414). Here, the coupling efficiency η is calculated by using the above Formula 1.

Next, it is determined whether or not η>ηₘₐₓ is satisfied (step S415), and in a case where η>ηₘₐₓ is satisfied (step S415: YES), the optical axis angle θ_{c} is set as the optimum optical axis angle θ which is a variable (step S416).

Next, η is set as the maximum coupling efficiency ηₘₐₓ which is a variable (step S417).

Next, +0.01 is added to the optical axis angle θ_{c} (step S418). Note that a value other than +0.01 may be added.

Thereafter, the processes in steps S414 to S418 are repeatedly executed until it is determined in step S413 that θc≤100 is not satisfied (step S413: NO).

Through the optimum transmission optical axis angle calculation processing (steps S411 to S418) in step S41 described above, it is possible to calculate the optimum transmission optical axis angle (here, the optimum transmission optical axis angle=9.91 mrad) at which the coupling efficiency is maximized at the distance to the observation target (here, the distance “7 m” to the smoke Ob2).

As described above, in the first automatic adjustment of the transmission optical axis angle, the coupling efficiency under the initial condition is 0.591, and the coupling efficiency (angle) under the optimum condition is 0.720 (θ_{c}=9.91 mrad) (see FIGS. 30A and 30B). That is, according to the first automatic adjustment of the transmission optical axis angle, a coupling efficiency improvement effect of about 13% is realized.

### <Second Automatic Adjustment of Transmission Optical Axis Angle>

Next, second automatic adjustment of the transmission optical axis angle will be described. Hereinafter, differences from the first automatic adjustment of the transmission optical axis angle will be mainly described.

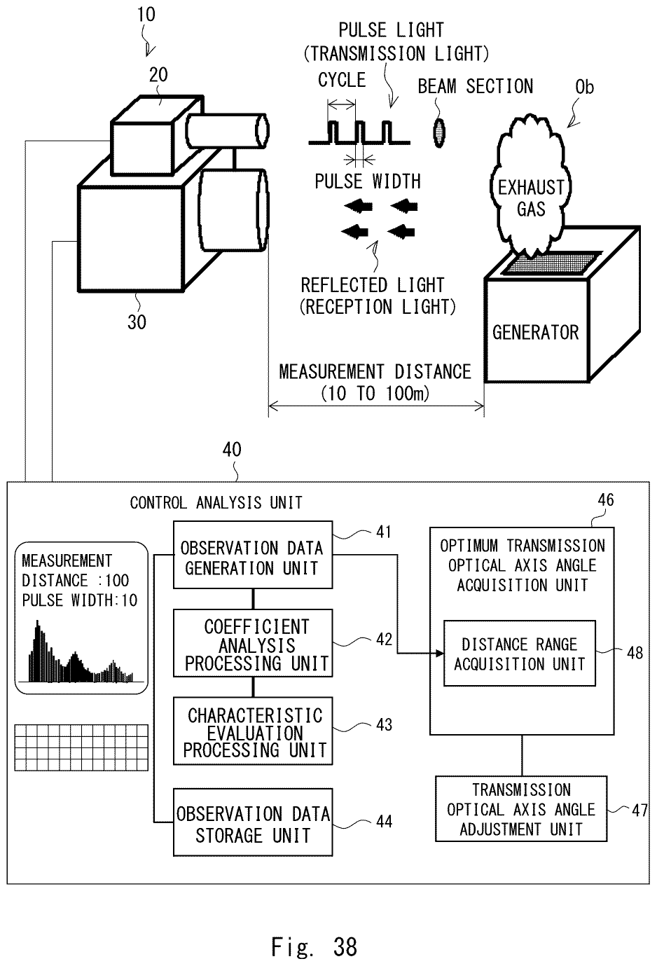

FIG. 38 is a schematic configuration diagram of the observation apparatus 10 used for the second automatic adjustment of the transmission optical axis angle.

In the second automatic adjustment of the transmission optical axis angle, as shown in FIG. 38, the control analysis unit 40 including a distance range acquisition unit 48 is used instead of the distance acquisition unit 45 in FIG. 37.

The distance range acquisition unit 48 acquires a distance range of the observation target object.

The optimum transmission optical axis angle acquisition unit 46 acquires an optimum transmission optical axis angle that is a transmission optical axis angle at which the coupling efficiency regarding the distance range (for example, an average coupling efficiency of a distance range of an observation target that will be described later) is maximized, in a case where a coupling efficiency is the area of the superimposed region of the transmission light visual field and a reception light visual field/the area of the transmission light visual field, and the angle between the transmission optical axis of the transmission light visual field and the reception optical axis of the reception light visual field is the transmission optical axis angle θc.

The transmission optical axis angle adjuster 47 adjusts the transmission optical axis angle θc of the transmission unit to the optimum transmission optical axis angle acquired by the optimum transmission optical axis angle acquisition unit 46.

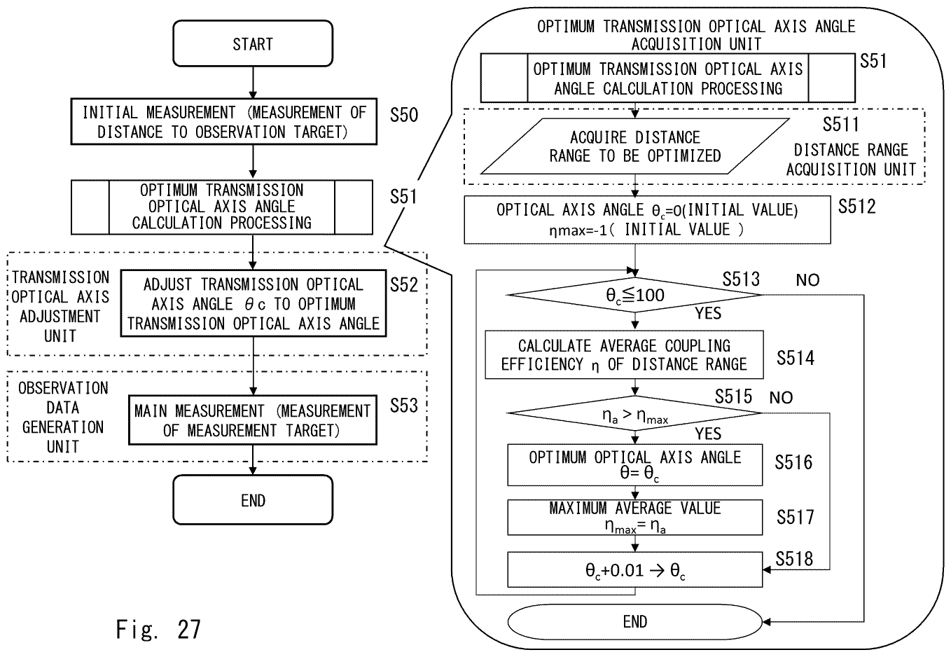

FIG. 27 is a flowchart showing second automatic adjustment of the transmission optical axis angle. The processing in FIG. 27 is started, for example, when an operator performs a predetermined operation on the observation apparatus 10 (for example, an automatic adjustment start switch for the transmission optical axis angle is turned on). Although not shown, when the operator performs a predetermined operation on the observation apparatus 10, the observation apparatus 10 (processor) executes a predetermined program read from the storage unit (for example, a ROM) into the memory (for example, a RAM), thereby executing each process (steps S50 to S53) in FIG. 27.

Hereinafter, it is assumed that L (transmission/reception optical axis distance) is 85 mm, Da (transmission diameter) is 60 mm, Db (reception diameter) is 100 mm, θa (transmission spread angle) is 10 mrad, θb (reception spread angle) is 5 mrad, and θc (transmission optical axis angle) is variable (adjustment target), and an initial condition is 5.88 mrad (a condition that an average coupling efficiency in a range of 1 to 100 m is maximized).

First, as initial measurement, a distance range of an observation target is measured (step S50). This is realized by the distance range acquisition unit 48. For example, in a case where an observation target can appear anywhere within the measurement range of 1 to 100 m, in order to first find the observation target in the initial measurement, a distance to the observation target is measured in a state in which the transmission optical axis angle θc (for example, θc=5.588 mrad) is set to achieve coupling efficiency suitable for measurement in a wide range, for example, a range of about 100 m.

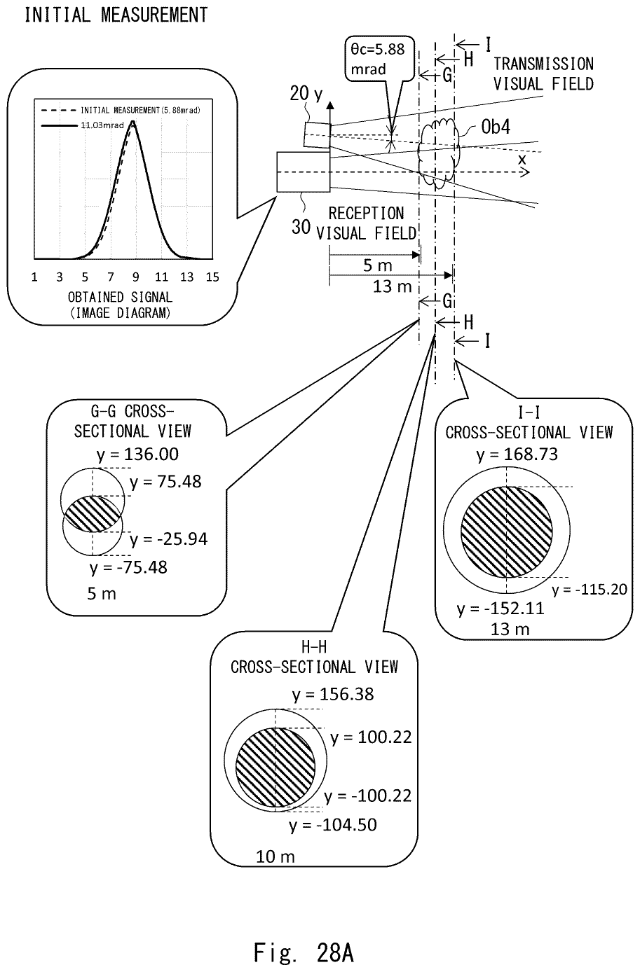

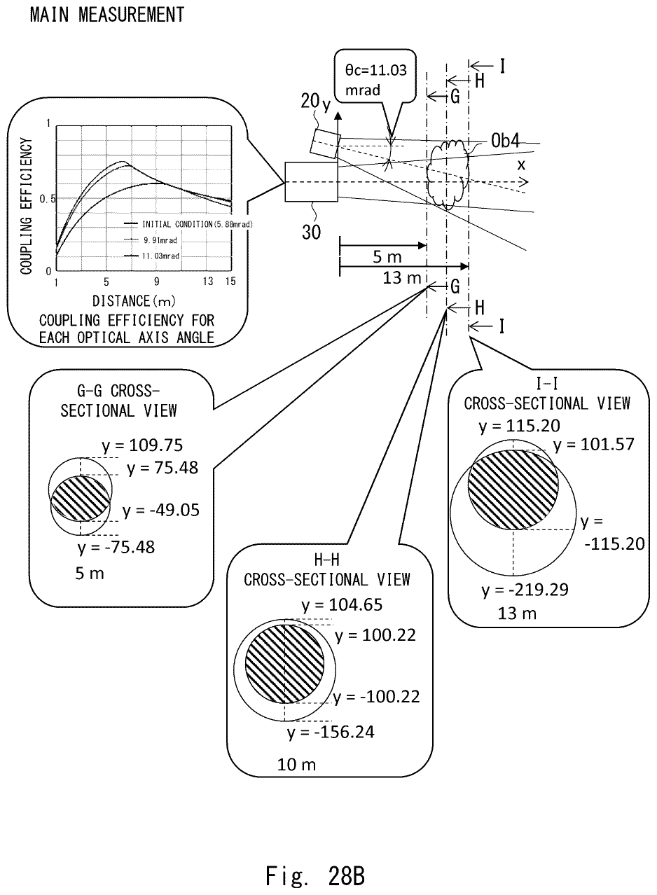

FIG. 28A is a diagram for describing initial measurement in the second automatic adjustment of the transmission optical axis angle, and FIG. 28B is a diagram for describing main measurement.

Here, it is assumed that, as a result of the measurement in step 50, smoke Ob4 that is an observation target having a range of 5 to 13 m is found as shown in FIG. 28A. In this case, an average value of the coupling efficiency in the initial measurement is, for example, 0.573. The transmission optical axis angle θc (for example, θc=5.588 mrad) in the initial setting is the initial measurement angle of the present disclosure, and one stored in advance in the storage unit (not shown) may be used, or one input or selected by the operator may be used. The average value of the coupling efficiency can be accurately obtained by integrating the coupling efficiency in the distance range and dividing the integrated value by the distance range. On the other hand, in a case where it is considered that the apparatus (the observation apparatus 10) has the distance resolution, the coupling efficiency is calculated for each interval of the resolution (for example, every about 0.15 m), and the average is obtained, so that the average value of the coupling efficiency can be obtained.

Next, optimum transmission optical axis angle calculation processing is executed (step S51). This is realized by the optimum transmission optical axis angle acquisition unit 46. The optimum transmission optical axis angle calculation processing is processing of calculating (acquiring) the optimum transmission optical axis angle at which the average coupling efficiency of the distance range of the observation target (here, the distance range of 5 to 13 m of the smoke Ob4 measured in step 50) is maximized. The optimum transmission optical axis angle calculation processing will be described later. Here, it is assumed that 11.03 mrad is calculated (acquired) as the optimum transmission optical axis angle as a result of step S51. Step S51 is an example of an optimum transmission optical axis angle acquisition unit of the present disclosure.

Next, the transmission optical axis angle θc is adjusted (set) to the optimum transmission optical axis angle calculated in step S51=11.03 mrad (the main measurement angle of the present disclosure) (step S52). This is realized by the transmission optical axis angle adjustment unit 47. Step S52 is an example of a transmission optical axis adjustment unit of the present disclosure.

Next, as the main measurement, the observation target is measured in a state in which the transmission optical axis angle is adjusted to the optimum transmission optical axis angle calculated in step S51 (step S53). Specifically, after adjusting the transmission optical axis angle θc to the optimum transmission optical axis angle, the observation data generation unit 41 generates LiDAR data that is observation data on the basis of a signal output from the light receiving element 35. The generated LiDAR data is stored in a built-in or external storage unit (not shown) accessible by the observation apparatus 10 (processor). Here, in order to determine the property of the smoke Ob4 existing in the distance range of 5 to 13 m, the smoke Ob4 existing in the distance range of 5 to 13 m is measured in a state in which the transmission optical axis angle θc is adjusted to the optimum transmission optical axis angle=11.03 mrad calculated in step S51. In this case, since it is most important to see the smoke Ob4 existing in the distance range of 5 to 13 m, the coupling efficiency in the main measurement, that is, the average coupling efficiency of the distance range of 5 to 13 m of the smoke Ob4, is higher than the coupling efficiency “0.573” in the initial measurement, and is, for example, 0.631.

In a case where the measurement of the observation target is performed in a state in which the transmission optical axis angle is adjusted to the optimum transmission optical axis angle as described above, the signal intensity of the reflected light (reflected pulse light) reflected by the observation target and returning into the reception light visual field is also maximized, Y(R) in the LiDAR equation increases, and P(R) in the LiDAR equation also increases. On the other hand, even if the transmission optical axis angle θc is adjusted to maximize the coupling efficiency at the distance to the observation target, the coupling efficiency does not affect a noise component (electrical noise, diffuse reflection noise, and ambient light noise derived from the apparatus). As a result, an S/N ratio of the signal (the output signal of the light receiving element 35) obtained from the observation target (here, the smoke Ob4 existing in the distance range of 5 to 13 m) is improved. Since the S/N ratio is improved as described above, not only the distance to the observation target but also the property determination of the observation target (here, the smoke Ob4 existing in the distance range of 5 to 13 m) that requires more detailed information such as an intensity of the signal from the observation target can be easily performed. For example, it is possible to determine the properties of more targets.

Next, the optimum transmission optical axis angle calculation processing in step S51 will be described.

Steps S511 to S518 in FIG. 27 are an example of a flowchart showing the optimum transmission optical axis angle calculation processing in step S51. The processes in steps S511 to S518 are executed by the observation apparatus 10 (processor) executing a predetermined program read from the storage unit (for example, a ROM) into the memory (for example, a RAM).

First, a distance range to be optimized is acquired (step S511). This is realized by the distance range acquisition unit 48. For example, the distance range acquisition unit 48 acquires the distance range of 5 to 13 m of the smoke Ob4 measured in step S50 as the distance range to be optimized. Step S511 is an example of a distance range acquisition unit of the present disclosure. For example, the distance range acquisition unit 45 calculates the distance range of the target object from the observation data (distance data) generated by the observation data generation unit 41 of the control analysis unit 40 in the initial measurement.

Next, the optical axis angle θ_{c} and ηmax as variables are respectively set to 0 and −1 as initial values (step S512).

Next, it is determined whether or not the optical axis angle θ_{c}≤100 is satisfied (step S513), and in a case where the optical axis angle θ_{c}≤100 is satisfied (step S513: YES), the average coupling efficiency ηₐ in the distance range of 5 to 13 m is calculated (step S514). Here, the average coupling efficiency ηₐ is obtained by dividing the distance range for each distance resolution of the apparatus, calculating the coupling efficiency at each division, and averaging the coupling efficiencies.

Next, it is determined whether or not ηₐ>ηₘₐₓ is satisfied (step S515), and in a case where ηₐ>ηₘₐₓ is satisfied (step S515: YES), the optical axis angle θ_{c} is set as the optimum optical axis angle θ which is a variable (step S516).

Next, ηₐ is set as the maximum coupling efficiency ηₘₐₓ which is a variable (step S517).

Next, +0.01 is added to the optical axis angle θ_{c} (step S518). Note that a value other than +0.01 may be added.

Thereafter, the processes in steps S514 to S518 are repeatedly executed until it is determined in step S513 that θ_{c}≤100 is not satisfied (step S513: NO).

Through the optimum transmission optical axis angle calculation processing (steps S511 to S518) in step S51 described above, it is possible to calculate the optimum transmission optical axis angle (here, the optimum transmission optical axis angle=11.03 mrad) at which the average coupling efficiency of the distance range of the observation target (here, the distance range of 5 to 13 m of the smoke Ob4) is maximized.

As described above, in the second automatic adjustment of the transmission optical axis angle, the coupling efficiency average value under the initial condition is 0.573, and the average coupling efficiency (angle) under the optimum condition is 0.631 (θc=11.03 mrad) (see FIGS. 30A and 30B). That is, according to the second automatic adjustment of the transmission optical axis angle, an average coupling efficiency improvement effect of about 6% is realized.

In the second automatic adjustment of the transmission optical axis angle, an example in which the optimum transmission optical axis angle at which the average coupling efficiency of the distance range of the observation target is maximized is calculated as the optimum transmission optical axis angle in step S51 has been described, but the present disclosure is not limited thereto.

For example, in step S51, another coupling efficiency (for example, a minimum coupling efficiency or a central coupling efficiency) related to the distance range of the observation target (here, the distance range of 5 to 13 m of the smoke Ob4) may be calculated as a coupling efficiency for the optimum transmission optical axis angle.

### <Third Automatic Adjustment of Transmission Optical Axis Angle (Optical Axis)>

Next, third automatic adjustment of the transmission optical axis angle (optical axis) will be described. Hereinafter, differences from the second automatic adjustment of the transmission optical axis angle will be mainly described.

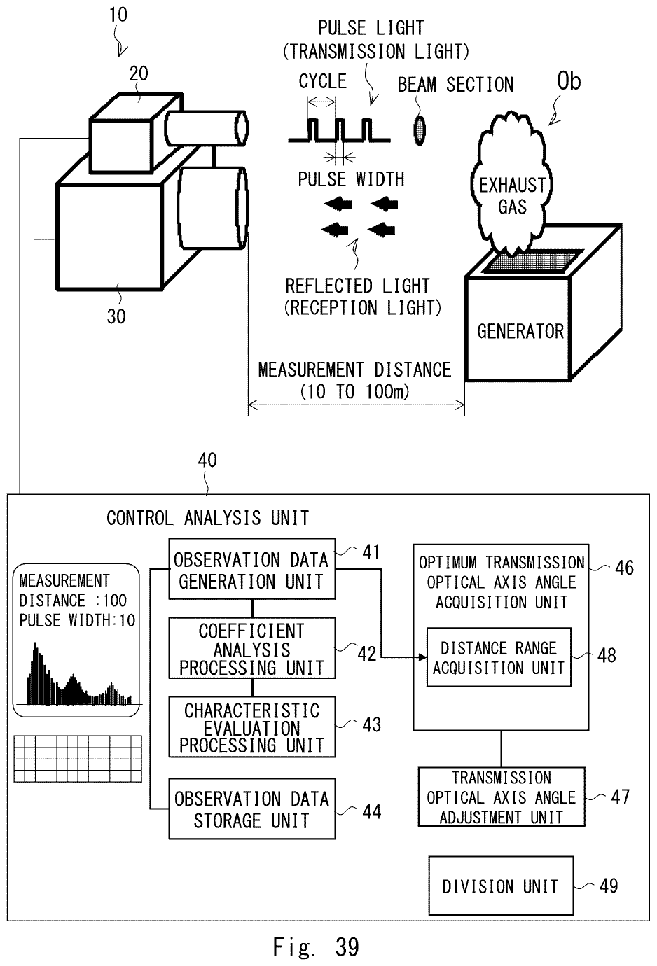

FIG. 39 is a schematic configuration diagram of the observation apparatus 10 used for the third automatic adjustment of the transmission optical axis angle.

In the third automatic adjustment of the transmission optical axis angle, as shown in FIG. 39, an observation apparatus 10 in which a division unit 49 is added to the observation apparatus 10 in FIG. 38 is used.

The distance range acquisition unit 48 acquires a distance range of the observation target object.

The division unit 49 divides the distance range of the observation target object acquired by the distance range acquisition unit 48. In this case, the distance range may be divided in consideration of the distance resolution of the apparatus (observation apparatus 10).

The optimum transmission optical axis angle acquisition unit 46 acquires the optimum transmission optical axis angle that is the transmission optical axis angle at which the coupling efficiency is maximized for each interval after division (or each distance after division) by the division unit 49.

The transmission optical axis adjustment unit 47 adjusts the transmission optical axis angle θc to the optimum transmission optical axis angle for each interval after division (distance after division).

After adjusting the transmission optical axis angle θc to the optimum transmission optical axis angle for each interval after division (distance after division), the control analysis unit 40 generates LiDAR data that is observation data on the basis of a signal output from the light receiving element 35.

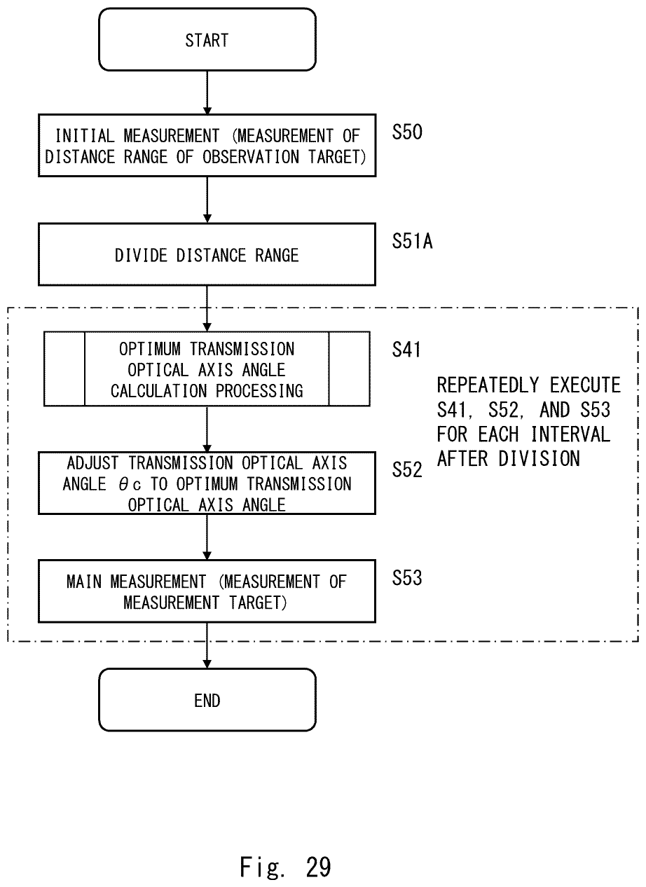

FIG. 29 is a flowchart showing the third automatic adjustment of the transmission optical axis angle. The processing in FIG. 29 is started, for example, when an operator performs a predetermined operation on the observation apparatus 10 (for example, an automatic adjustment start switch for the transmission optical axis angle is turned on). Although not shown, when the operator performs a predetermined operation on the observation apparatus 10, the observation apparatus 10 (processor) executes a predetermined program read from the storage unit (for example, a ROM) into the memory (for example, a RAM), thereby executing each process (steps S50 to S53) in FIG. 29.

Hereinafter, it is assumed that L (transmission/reception optical axis distance) is 85 mm, Da (transmission diameter) is 60 mm, Db (reception diameter) is 100 mm, θa (transmission spread angle) is 10 mrad, θb (reception spread angle) is 5 mrad, and θc (transmission optical axis angle) is variable (adjustment target), and an initial condition is 5.88 mrad (a condition that an average coupling efficiency in a range of 1 to 100 m is maximized).

First, as initial measurement, a distance range of an observation target is measured (step S50). This is realized by the distance range acquisition unit 48. For example, in a case where an observation target can appear anywhere within the measurement range of 1 to 100 m, in order to first find the observation target in the initial measurement, a distance to the observation target is measured in a state in which the transmission optical axis angle θc (for example, θc=5.588 mrad which is an initial measurement angle of the present disclosure) is set to achieve coupling efficiency suitable for measurement in a wide range, for example, a range of about 100 m. Here, as a result of the measurement in step 50, although not shown, it is assumed that smoke that is an observation target having a range of 5 to 23 m is found. In this case, an average value of the coupling efficiency in the initial measurement is, for example, 0.573. As the transmission optical axis angle θc (for example, θc=5.588 mrad) in the initial setting, one stored in advance in a storage unit (not shown) may be used, or one input or selected by the operator may be used.

Next, the distance range acquired in step S50 is divided (step S51A). This is realized by the division unit 49. For example, the distance range is divided at intervals of 1 m (5, 6, 7, . . . , 23 m). Step S51A is an example of the division unit of the present disclosure.

Next, for each interval (or distance) after division, the optimum transmission optical axis angle calculation processing (step S41), the processing of adjusting (setting) the transmission optical axis angle θc to the optimum transmission optical axis angle (the main measurement angle of the present disclosure) calculated in step S41 (step S52), and the processing of performing the main measurement (the measurement of the observation target in a state in which the transmission optical axis angle is adjusted to the optimum transmission optical axis angle calculated in step S41) (step S53) are repeatedly executed. The optimum transmission optical axis angle calculation processing (step S41) is realized by the optimum transmission optical axis angle acquisition unit 46. The processing of adjusting (setting) the transmission optical axis angle θc to the optimum transmission optical axis angle calculated in step S41 (step S52) is realized by the transmission optical axis adjustment unit 47. The processing of performing the main measurement (the measurement of the observation target in a state in which the transmission optical axis angle is adjusted to the optimum transmission optical axis angle calculated in step S41) (step S53) is realized by the control analysis unit 40 (observation data generation unit).

As described above, according to the present embodiment, the S/N ratio can be improved by increasing the signal intensity from the observation target in the observation apparatus 10 that performs LiDAR observation by using deep ultraviolet light.

Next, modified examples will be described.

In the above embodiment, the example in which the optimum transmission optical axis angle calculation processing (Steps S41 and S51) is executed in the first to third automatic adjustment of the transmission optical axis angle (optical axis) has been described, but the present disclosure is not limited thereto.

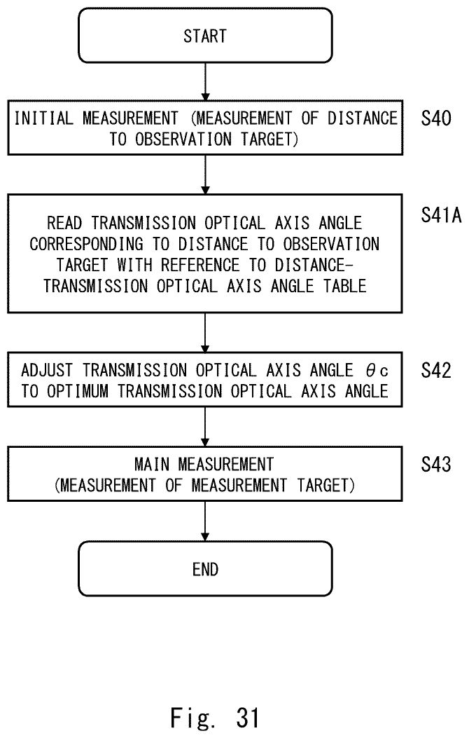

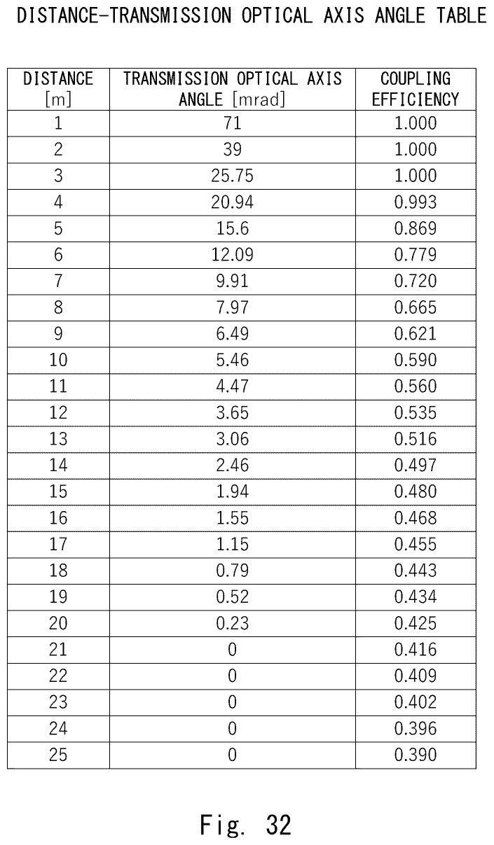

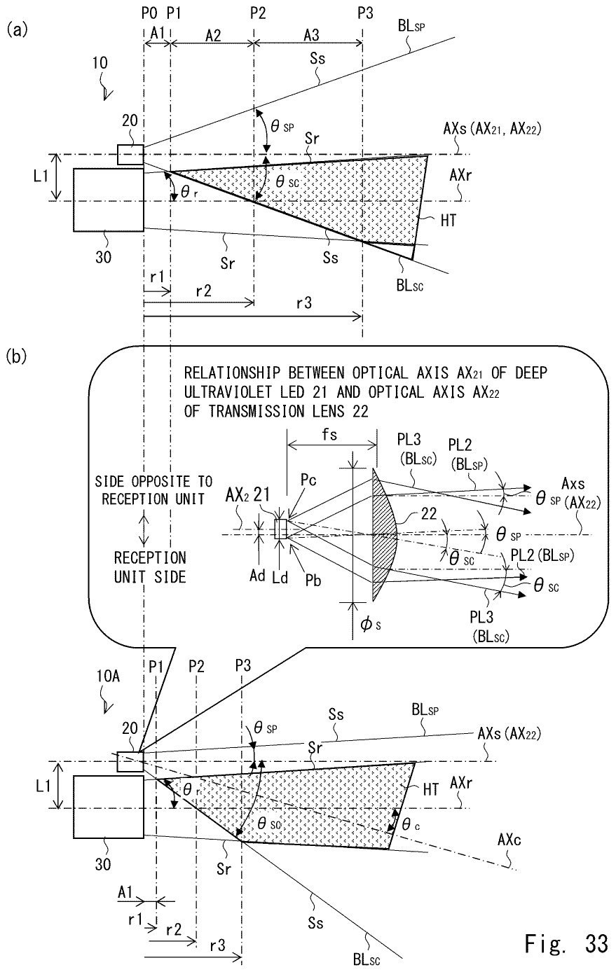

FIG. 31 is a flowchart showing a modified example of the first automatic adjustment of the transmission optical axis angle (optical axis). FIG. 32 shows an example of a distance-transmission optical axis angle table.

For example, as shown in FIG. 31, step S41A may be provided instead of step S41 for executing the optimum transmission optical axis angle calculation processing in the first automatic adjustment of the transmission optical axis angle. In step S41, the transmission optical axis angle θc=9.91 mrad corresponding to the distance to the observation target measured in step S40 (for example, the distance of 7 m to the smoke Ob2 measured in step 40) may be read with reference to the distance-transmission optical axis angle table (see FIG. 32). In this case, in step S42, the transmission optical axis angle θc is adjusted (set) to the optimum transmission optical axis angle=9.91 mrad read in step S41A. The distance-transmission optical axis angle table (see FIG. 32) is a table in which the distance, the optimum transmission optical axis angle at which the coupling efficiency at the distance is maximized, and the coupling efficiency are associated with each other. The coupling efficiency may be omitted. The distance-transmission optical axis angle table may be preliminarily calculated at the design stage, for example, and may be stored in advance in a built-in or external storage unit (for example, a ROM) accessible by the observation apparatus 10 (processor) (not shown).

Although the modified example of the first automatic adjustment of the transmission optical axis angle has been described above, the same applies to modified examples of the second and third automatic adjustment of the transmission optical axis angle.

According to the present modified example, since the optimum transmission optical axis angle calculation processing (steps S41 and S51) can be omitted, the processing speed is improved.

Next, a configuration of the observation apparatus 10 capable of adjusting the transmission optical axis angle θc will be described.

### Second Embodiment

First, an observation apparatus 10 according to a first embodiment will be described.

FIG. 33(a) is a longitudinal sectional view (schematic view) of the observation apparatus 10 of the first embodiment.

In the observation apparatus 10 of the first embodiment, an optical axis AX₂₁ of the deep ultraviolet LED 21 (light emitting surface) which is a semiconductor light emitting element passes through the center of the light emitting surface and extends in a direction perpendicular to the light emitting surface (see FIG. 10). The optical axis AX₂₁ of the deep ultraviolet LED 21 (light emitting surface) and the reference axis, here, an optical axis AX₂₂ of the transmission lens 22 (and an optical axis AXs of the transmission unit 20) coincide (substantially coincide) with each other (see FIG. 10). Therefore, as shown in FIG. 33(a), a transmission light far-side viewing angle θ_{SP} and a transmission light near-side viewing angle θ_{SC} are equal (transmission light far-side viewing angle θ_{SP}=transmission light near-side viewing angle θ_{SC}).

FIG. 33(b) is a longitudinal sectional view (schematic view) of an observation apparatus 10A of the second embodiment. FIG. 33(b) shows, for example, a state in which the transmission optical axis angle θc is changed from the state in FIG. 33(a).

Specifically, in the second embodiment, the deep ultraviolet LED 21 is disposed at a position eccentric to the reference axis, here, by an inter-optical axis distance Ad from the optical axis AXs of the transmission unit 20 (the optical axis AX₂₂ of the transmission lens 22) to the side opposite to the reception unit 30 (the upper side in FIG. 33(b)). That is, the optical axis AX₂₁ of the deep ultraviolet LED 21 is shifted by the inter-optical axis distance Ad in a direction away from the reception unit 30 with respect to the reference axis. In this case, the optical axis AX₂₁ of the eccentric deep ultraviolet LED 21 and the reference axis are parallel to each other. Other than that, the observation apparatus 10A of the second embodiment has the same configuration as that of the observation apparatus 10 of the first embodiment.

As shown in FIG. 33(b), light PL2 emitted from a position Pb shifted downward with respect to the center of the deep ultraviolet LED 21 (light emitting surface), for example, the lowermost end of the deep ultraviolet LED 21 (light emitting surface) is refracted by the transmission lens 22 and transmitted in a direction inclined upward by the transmission light far-side viewing angle θ_{SP} with respect to the reference axis, here, the optical axis AXs of the transmission unit 20 (the optical axis AX₂₂ of the transmission lens 22). The same applies to light emitted from other positions shifted downward with respect to the center of the deep ultraviolet LED 21 (light emitting surface).

Similarly, light PL3 emitted from a position Pc shifted upward with respect to the center of the deep ultraviolet LED 21 (light emitting surface), for example, the uppermost end of the deep ultraviolet LED 21 (light emitting surface) in FIG. 33(b) is refracted by the transmission lens 22 and transmitted in a direction inclined downward by the transmission light near-side viewing angle θ_{SC} with respect to the reference axis, here, the optical axis AXs of the transmission unit 20. The same applies to light emitted from other positions shifted upward with respect to the center of the deep ultraviolet LED 21 (light emitting surface).

In this case, since the optical axis AX₂₁ of the deep ultraviolet LED 21 is shifted by the inter-optical axis distance Ad in the direction away from the reception unit 30 with respect to the reference axis, the transmission light far-side viewing angle θ_{SP}<the transmission light near-side viewing angle θ_{SC} is established.

That is, the transmission optical axis angle θc can be adjusted by moving the position of the deep ultraviolet element LED 21 in a direction in which the optical axis AX₂₁ of the deep ultraviolet LED 21 is perpendicular to the optical axis AXs of the transmission unit 20 (the optical axis AX₂₂ of the transmission lens 22).

For example, in a case where a size Ld of the deep ultraviolet LED 21 (light emitting surface) is 1.04 mm, a transmission aperture φs is 60 mm, a focal length fs is 52 mm, and the reception light viewing angle θr of the reception unit 30 is 3 mrad (0.17°), a condition that the transmission light near-side viewing angle θ_{SC} is maximized is a case where the transmission light far-side viewing angle θ_{SP} is the same as the reception light viewing angle θr (θ_{SP}=θr). In this case, the inter-optical axis distance Ad is 0.364 mm, and the transmission light near-side viewing angle θ_{SC} is 17 mrad (0.974°). Therefore, a possible range of the inter-optical axis distance Ad is a range of 0<the inter-optical axis distance Δd≤0.364 mm.

Note that, in the above description of the configuration for adjusting the transmission optical axis angle θc, a case where the transmission optical axis angle θc is changed from FIG. 33(a) to FIG. 33(b) has been described as an example. However, a specific transmission optical axis angle θc at the time of initial measurement is set to correspond to the observation target object, and a specific transmission optical axis angle θc at the time of main measurement corresponds to one calculated as the optimum transmission optical axis angle.

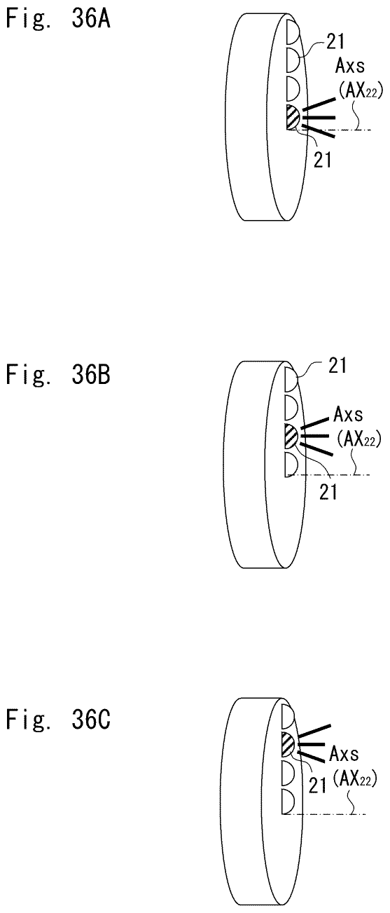

As shown in FIGS. 36A, 36B, and 36C, the transmission optical axis angle θc can be adjusted in the same manner as described above by disposing a plurality of deep ultraviolet LEDs 21 in a row in the up-down direction (vertical direction) above the optical axis AX₂₂ of the transmission lens 22 (and the optical axis AXs of the transmission unit 20) and individually controlling on/off of each deep ultraviolet LED 21.

### Third Embodiment

Next, as a third embodiment, an observation apparatus 10B adopting a configuration capable of adjusting the transmission optical axis angle θc will be described.

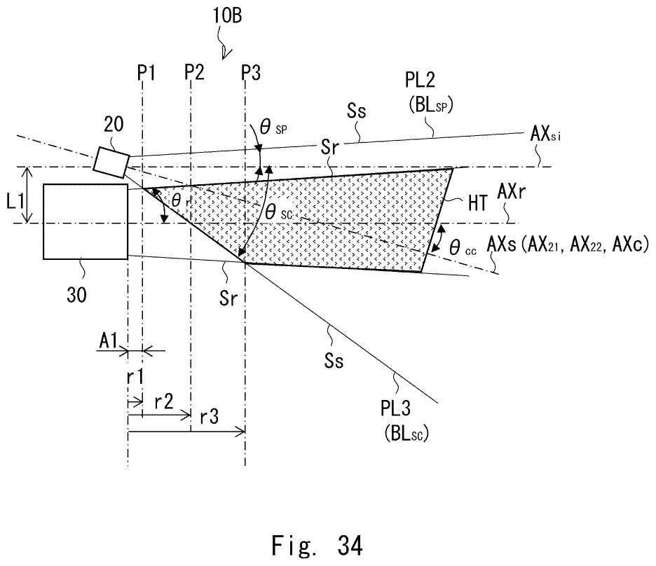

FIG. 34 is a longitudinal sectional view (schematic view) of the observation apparatus 10B of the third embodiment. In the third embodiment, the optical axis AXs of the transmission unit 20 (the optical axis AX₂₂ of the transmission lens 22 in the transmission unit 20) is inclined relative to the optical axis AXr of the reception unit 30, and the optical axis AXs of the transmission unit 20 and the optical axis AXr of the reception unit 30 intersect each other. As a result, the optical axis of the transmission light (that is, the center line AXc of the transmission light visual field Ss) and the optical axis of the reception light (that is, the center line AXr of the reception light visual field Sr) intersect each other.

That is, the transmission optical axis angle θc can be adjusted by changing the relative angle of the optical axis AXs of the transmission unit 20 (the optical axis AX₂₂ of the transmission lens 22 in the transmission unit 20) with respect to the optical axis AXr of the reception unit 30.

For example, in a case where the transmission light viewing angle θs of the transmission unit 20 is 10 mrad and the reception light viewing angle θr of the reception unit 30 is 3 mrad, the maximum inclination angle θcc of the transmission unit 20 is 7 mrad obtained by subtracting the transmission light far-side viewing angle θ_{SP} (=θr)=3 mrad from the transmission light viewing angle θs=10 mrad. In addition, a possible range of the inclination angle θcc of the transmission unit 20 is 0 mrad<θcc≤7 mrad.

### Fourth Embodiment

Next, as a fourth embodiment, an observation apparatus 10C adopting a configuration capable of adjusting the transmission optical axis angle θc will be described.

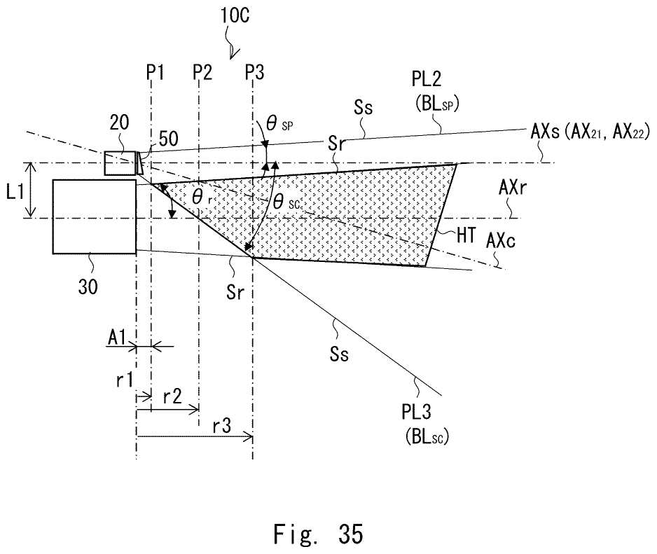

FIG. 35 is a longitudinal sectional view (schematic view) of an observation apparatus 10C of the fourth embodiment.

In a modified example, as shown in FIG. 35, an optical element 50 that controls pulse light emitted by the transmission unit 20 is provided.

The optical element 50 is, for example, a prism. The prism includes a drive mechanism and is disposed in front of the transmission unit 20 on the side opposite to reception unit 30. The number of prisms may be one or plural.

That is, the transmission optical axis angle θc can be adjusted by changing a prism position by using the drive mechanism.

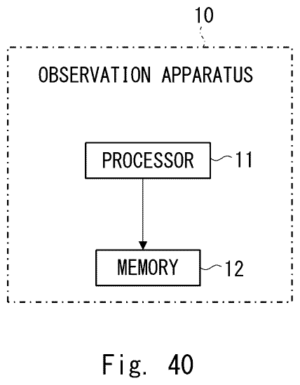

Next, a hardware configuration example of the observation apparatus 10 described in the above-described embodiment will be described. FIG. 40 is a diagram showing a hardware configuration example of the observation apparatus 10 according to the present disclosure.

Referring to FIG. 40, the observation apparatus 10 includes a processor 11 and a memory 12. The processor 11 reads software (computer program) from the memory 12 and executes the software, thereby performing the processing of the observation apparatus 10 described by using the flowcharts in the above-described embodiment. The processor 11 may be, for example, a microprocessor, a micro processing unit (MPU), or a central processing unit (CPU). The processor 11 may include a plurality of processors.

The memory 12 is configured by a combination of a volatile memory and a nonvolatile memory. The memory 12 may include a storage located away from the processor 12. In this case, the processor 11 may access the memory 12 through an input/output (I/O) interface (not shown).

In the example in FIG. 40, the memory 12 is used to store a software module group. The processor 11 can perform the processing of the observation apparatus 10 described in the above-described embodiments by reading the software module group from the memory 12 and executing the software module group.

As described with reference to FIG. 40, each of one or a plurality of processors included in the observation apparatus 10 executes one or a plurality of programs including an instruction group for causing a computer to perform the algorithm described with reference to the drawings.

In the above-described example, the program includes an instruction group (or software code) for causing the processor to perform one or more functions described in the embodiments. The program may be stored in a non-transitory computer-readable medium or a tangible storage medium. By way of example, and not limitation, computer-readable media or tangible storage media include a random-access memory (RAM), a read-only memory (ROM), a flash memory, a solid-state drive (SSD) or other memory technology, a CD-ROM, a digital versatile disc (DVD), Blu-ray® disc or other optical disk storages, a magnetic cassette, a magnetic tape, a magnetic disk storage, or other magnetic storage devices. The program may be transmitted on a transitory computer readable medium or a communication medium. By way of example, and not limitation, transitory computer-readable or communication media include electrical, optical, acoustic, or other forms of propagated signals.

Each numerical value described in each of the above embodiments is an example, and it is a matter of course that an appropriate numerical value different from this can be used.

Each of the above embodiments is merely an example in all respects. That is, the present disclosure is not to be construed as being limited by the description of each of the above embodiments. The present disclosure can be implemented in various other forms without departing from the spirit or main characteristics thereof.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An observation apparatus comprising:
a transmission unit, which has a transmission light visual field, configured to transmit, in the transmission light visual field, pulse light having a wavelength belonging to an ultraviolet region of a solar blind band;
a reception unit, which has a reception light visual field, configured to receive reflected light within the reception light visual field among pieces of reflected light of the pulse light reflected by an observation target object; and
a control analysis unit configured to receive a signal from the reception unit, wherein
the transmission unit includes
a semiconductor light emitting element configured to emit the pulse light, and
a transmission optical system configured to control the pulse light emitted by the semiconductor light emitting element such that the pulse light emitted by the semiconductor light emitting element is transmitted within the transmission light visual field,
the reception unit includes
a reception optical system configured to collect reflected light in the reception light visual field, and
a light receiving element configured to receive the collected reflected light and output a signal corresponding to the received reflected light,
the control analysis unit includes
a distance acquisition unit configured to acquire a distance to the observation target object,
an optimum transmission optical axis angle acquisition unit configured to acquire an optimum transmission optical axis angle that is a transmission optical axis angle at which a coupling efficiency at the distance is maximized in a case where a coupling efficiency is an area of a superimposed region of the transmission light visual field and the reception light visual field/an area of the transmission light visual field, and an angle between a transmission optical axis of the transmission light visual field and a reception optical axis of the reception light visual field is a transmission optical axis angle, and
a transmission optical axis adjustment unit configured to adjust the transmission optical axis angle of the transmission unit to the optimum transmission optical axis angle, and
the control analysis unit includes an observation data generation unit configured to adjust the transmission optical axis angle to the optimum transmission optical axis angle, and then generate LiDAR data that is observation data on the basis of the signal output from the light receiving element.

2. An observation apparatus comprising:
a transmission unit, which has a transmission light visual field, configured to transmit, in the transmission light visual field, pulse light having a wavelength belonging to an ultraviolet region of a solar blind band;
a reception unit, which has a reception light visual field, configured to receive reflected light within the reception light visual field among pieces of reflected light of the pulse light reflected by an observation target object; and
a control analysis unit configured to receive a signal from the reception unit, wherein
the transmission unit includes
a semiconductor light emitting element configured to emit the pulse light, and
a transmission optical system configured to control the pulse light emitted by the semiconductor light emitting element such that the pulse light emitted by the semiconductor light emitting element is transmitted within the transmission light visual field,
the reception unit includes
a reception optical system configured to collect reflected light in the reception light visual field, and
a light receiving element configured to receive the collected reflected light and output a signal corresponding to the received reflected light,
the control analysis unit includes
a distance range acquisition unit configured to acquire a distance range of the observation target object,
an optimum transmission optical axis angle acquisition unit configured to acquire an optimum transmission optical axis angle that is a transmission optical axis angle corresponding to a coupling efficiency related to the distance range in a case where a coupling efficiency is an area of a superimposed region of the transmission light visual field and the reception light visual field/an area of the transmission light visual field, and an angle between a transmission optical axis of the transmission light visual field and a reception optical axis of the reception light visual field is a transmission optical axis angle, and
a transmission optical axis adjustment unit that adjusts the transmission optical axis angle of the transmission unit to the optimum transmission optical axis angle, and
the control analysis unit adjusts the transmission optical axis angle to the optimum transmission optical axis angle, and then generates LiDAR data that is observation data on the basis of the signal output from the light receiving element.

3. The observation apparatus according to claim 1, further comprising a division unit configured to divide a distance range of the observation target object into intervals, wherein
the optimum transmission optical axis angle acquisition unit acquires an optimum transmission optical axis angle that is a transmission optical axis angle at which the coupling efficiency is maximized for each of the intervals after division,
the transmission optical axis adjustment unit adjusts the transmission optical axis angle to the optimum transmission optical axis angle for each of the intervals after the division, and
the control analysis unit adjusts the transmission optical axis angle to the optimum transmission optical axis angle for each of the intervals after the division, and then generates LiDAR data that is observation data on the basis of the signal output from the light receiving element.

4. An observation apparatus comprising:
a transmission unit, which has a transmission light visual field, configured to transmit, in the transmission light visual field, pulse light having a wavelength belonging to an ultraviolet region of a solar blind band; and
a reception unit, which has a reception light visual field, configured to receive reflected light in the reception light visual field among pieces of reflected light of the pulse light reflected by the observation target object, and output a signal corresponding to the received reflected light, wherein
a transmission optical axis angle formed between a transmission optical axis of the transmission light visual field and a reception optical axis of the reception light visual field is controllable,
the transmission unit transmits the pulse light in the transmission light visual field in a state in which the transmission optical axis angle is set to an initial measurement angle, and performs initial measurement related to a distance of the observation target object on the basis of the signal output from the reception unit,
the transmission optical axis angle is set to a main measurement angle, and
main measurement in which the transmission unit transmits the pulse light in the transmission light visual field in a state in which the transmission optical axis angle is set to the main measurement angle, and generates LiDAR data that is observation data on the basis of the signal output from the reception unit is performed, and
the main measurement angle is an angle at which a coupling efficiency in the main measurement>a coupling efficiency in the initial measurement is satisfied in a case where the coupling efficiency is an area of a superimposed region of the transmission light visual field and the reception light visual field/an area of the transmission light visual field.

5. The observation apparatus according to claim 4, wherein
the initial measurement related to the distance of the observation target object is measurement of a distance to the observation target object, and
the coupling efficiency in the main measurement and the coupling efficiency in the initial measurement are coupling efficiencies at the distance of the observation target object at the initial measurement angle and the main measurement angle, respectively.

6. The observation apparatus according to claim 5, wherein the main measurement angle is an angle at which the coupling efficiency at the distance of the observation target object in the main measurement is maximized.

7. The observation apparatus according to claim 4, wherein
the initial measurement related to the distance of the observation target object is measurement of a distance range of the observation target object, and
each of the coupling efficiency in the main measurement and the coupling efficiency in the initial measurement is a coupling efficiency related to the distance range of the observation target object.

8. The observation apparatus according to claim 7, wherein
the coupling efficiency related to the distance range of the observation target object is an average coupling efficiency of the distance range of the observation target object, and
the main measurement angle is an angle at which the average coupling efficiency of the distance range of the observation target object is maximized.

9. The observation apparatus according to claim 4, wherein
the initial measurement related to the distance of the observation target object is measurement of a distance range of the observation target object, and
in the main measurement,
the distance range of the measurement target object is divided into intervals,
for each of the intervals after division,
the transmission optical axis angle is set to a main measurement angle larger than the initial measurement angle, and
in a state in which the transmission optical axis angle is set to the main measurement angle, the transmission unit transmits the pulse light in the transmission light visual field, and generates LiDAR data that is observation data on the basis of the signal output from the reception unit.

10. An observation method using an observation apparatus including
a transmission unit, which has a transmission light visual field, configured to transmit, in the transmission light visual field, pulse light having a wavelength belonging to an ultraviolet region of a solar blind band, and
a reception unit, which has a reception light visual field, configured to receive reflected light in the reception light visual field among pieces of reflected light of the pulse light reflected by the observation target object, and output a signal corresponding to the received reflected light, the observation method being a method of observing an observation target object by using the observation apparatus configured to be able to control a transmission optical axis angle formed between a transmission optical axis of the transmission light visual field and a reception optical axis of the reception light visual field, and comprising:
an initial measurement step in which the transmission unit transmits the pulse light in the transmission light visual field in a state in which the transmission optical axis angle is set to an initial measurement angle, and performs initial measurement related to a distance of the observation target object on the basis of the signal output from the reception unit;
a main measurement angle setting step of setting the transmission optical axis angle to a main measurement angle; and
a main measurement step of performing main measurement in which the transmission unit transmits the pulse light in the transmission light visual field in a state in which the transmission optical axis angle is set to the main measurement angle, and generates LiDAR data which is observation data on the basis of the signal output from the reception unit,
wherein the main measurement angle is an angle at which a coupling efficiency in the main measurement>a coupling efficiency in the initial measurement is satisfied in a case where the coupling efficiency is an area of a superimposed region of the transmission light visual field and the reception light visual field/an area of the transmission light visual field.
